(19) United States
(12) Patent Application Publication
(10) Pub. No.: US 2018/0173503 A1
(43) Pub. Date: Jun. 21, 2018

(54) SYSTEM AND METHOD FOR GRAPHICAL PROGRAMMING

(71) Applicants: Mehrdad Ghasemizadeh, Tehran (IR); Alireza Shirdel, Tehran (IR); Mohammad Aghababaie Alavijeh, Tehran (IR); Mahdi Ghasemizadeh, Tehran (IR)

(72) Inventors: Mehrdad Ghasemizadeh, Tehran (IR); Alireza Shirdel, Tehran (IR); Mohammad Aghababaie Alavijeh, Tehran (IR); Mahdi Ghasemizadeh, Tehran (IR)

(73) Assignee: Mehrdad Ghasmizadeh, Tehran (IR)

(21) Appl. No.: 15/899,348

(22) Filed: Feb. 19, 2018

Related U.S. Application Data
(60) Provisional application No. 62/460,817, filed on Feb. 19, 2017.

(51) Int. Cl. G06F 8/34; G06F 3/0481; G06F 8/30

(52) U.S. Cl. CPC G06F 8/34; G06F 3/04812; G06F 8/31; G06F 3/04817

(57) ABSTRACT

A system and method for graphical programming in which structures include internal or external trigger signals, and can be configured to administer and control all the processes within a graphical program. Each block includes its own input triggers, and each block can be activated via the output trigger of a connected block. Moreover, external triggers derived from the system can stimulate the graphical block independently.

### CROSS-REFERENCE TO RELATED APPLICATION

This application claims the benefit of priority from pending U.S. Provisional Patent Application Ser. No. 62/460,817, filed on Feb. 19, 2017, and entitled “A SYSTEM AND METHOD FOR GRAPHICAL PROGRAMMING,” which is incorporated herein by reference in its entirety.

### BACKGROUND

In order to generate a software program that can be executed or run by a computer, developers or programmers typically select a programming language, such as BASIC (Beginner's All-purpose Symbolic Instruction Code), Fortran, and C. Using such text-based languages, a programmer can write source code using the keywords, syntax, variable names, and data structures, among others. defined by the selected programming language. Each programming language typically defines its own unique syntax and keywords for performing various operations. The written source code can be converted by a compiler into a machine readable format that can be understood by the computer. If there are any errors in syntax or used incorrect keywords, the source code will not compile correctly.

In general, text-based programming languages follow up a control flow structure in which the statements, instructions, and functions are executed according to the sequential order of laying in the program code. The source code is typically written with a text editor and organized into a series of lines of code. Although simple programs may only need a few lines of code, complex programs often consume hundreds, thousands or tens of thousands of lines of code.

As computers become more widely used across nearly all industries, a working familiarity with coding or programming has become necessary even for those users who do not have a background in programming. Despite this growing need, such tasks remain a great challenge for novices. Even professional programmers are faced with difficulties in implementing optimized processes for so many different types of industries. In order to address such challenges, graphical programming was developed to provide a more simplified approach to programming. In graphical programming, also referred to as visual programming, blocks configured for execution of specific tasks are used rather than syntax. The graphical approach to programming allows a computer to process spatial representations in two or more dimensions. In contrast to text-based programming, which uses lines of code, graphical programming replaces text with pictures or symbols of physical things. Thus, graphical programming provides an approach that can be more intuitive and less cumbersome for some programmers. It also can be a more effective way to introduce computer programming to visual learners.

Graphical programs are often called Visual Programming Languages (VPLs). Graphical programming is most frequently used in the stages of engineering systems design. Engineers and programmers might use graphical programs to translate information about physical events, such as vibrations that occur during the testing of automotive engines, into visual readouts. Graphical programming tools also might be used to employ block diagrams, connectors and virtual instruments, such as temperature gauges. The result is a user interface that can be used to control and monitor an automated process. Graphical programs also are used to perform mathematical functions, such as those used in signal processing. Additionally, users can access databases of information on terrain, demographics and buildings. Such programs might be used in cellular system design. In addition, specialists of various domains benefit from graphical programming in complicated processes such as monitoring, extracting data, communication, instrumentation, automobile industry and aerospace. Data security and process control are also the best features of graphical programming which are essential for some applications.

However, an important feature that has not been addressed in graphical programming relates to the Multithreading-Multitasking concept. In text-based programming languages such as C, it is relatively straightforward to assign a dedicated thread to a process. However, in the graphical programming paradigm, programmers are not able to allocate processors targeted for a specific application. Thus, efficiently and dynamically handling the threads according to process characteristics remains an obstacle for graphical programming. For some graphical programming frameworks, timing control by precise triggering has been proposed as a solution. However, such a solution is associated with drawbacks. For example, the allocation is not optimal with respect to processor performance because it relies on trial and error. Furthermore, because it is a complex process, the task is inefficient.

There is, therefore, a need for a method and system that facilitates a data flow process for graphical programming and includes the flexibility of text-based programming.

### SUMMARY

This summary is intended to provide an overview of the subject matter of the present disclosure, and is not intended to identify essential elements or key elements of the subject matter, nor is it intended to be used to determine the scope of the claimed implementations. The proper scope of the present disclosure may be ascertained from the claims set forth below in view of the detailed description below and the drawings.

In one general aspect, the present disclosure describes a method of developing a computer application. The method includes opening a graphical program on a computer, where the computer includes a processor, data bus, random access memory, a display device, a network interface and a storage means on the computer for storing executable applications. The method also includes displaying a plurality of graphical blocks, the plurality of graphical blocks including a first graphical block, a second graphical block, and a third graphical block, and moving a cursor to drag a first wire from a first pin associated with the first graphical block to a second pin associated with the second graphical block, wherein the first pin represents an input and the second pin represents an output. The method further includes transmitting a first trigger output signal from the first graphical block to the second graphical block via the first wire, the first graphical block being in communication with the second graphical block via the first wire, and receiving the first trigger output signal as a first trigger input signal at the second graphical block.

The above general aspect may include one or more of the following features. In some implementations, the method further includes moving the cursor to drag a second wire from a third pin associated with the second graphical block to a fourth pin associated with the third graphical block, where the third pin represents an input and the fourth pin represents an output. In another example, the method also includes transmitting a second trigger output signal from the second graphical block to the third graphical block via the second wire, the second graphical block being in communication with the third graphical block via the second wire. In some cases, the method further involves receiving the second trigger output signal as a second trigger input signal at the third graphical block, thereby completing execution of a first thread. In some implementations, a bootstrap property is utilized for initialization of the first graphical block. As another example, the first graphical block, the second graphical block, and the third graphical block are executed sequentially. In one implementation, the second trigger output signal is not transmitted before the first trigger input signal is received. In some cases, the first graphical block receives a third trigger input signal while the first thread is being executed, thereby generating a second thread. In some implementations, the method includes executing the first thread and the second thread in parallel, while in other implementations, the method includes executing the first thread and the second thread in series.

In another general aspect, the present disclosure describes a method of developing a computer application. The method includes opening a graphical program on a computer, the computer including a processor, data bus, random access memory, a display device, a network interface and a storage means on the computer for storing executable applications. The method also includes displaying a plurality of graphical blocks, the plurality of graphical blocks including a switch block, a first graphical block, a first action block, and a first constant block, and activating the switch block. The method further involves stimulating, via the switch block, the first graphical block, thereby causing a first output signal to be transmitted from the first graphical block to the first action block, receiving the first output signal as a second input signal at the first action block, receiving a third input signal at the first action block from the first constant block, the third input signal including a data value that is a constant, and executing a first task associated with the first action block based on the second input signal and the third input signal.

The above general aspect may include one or more of the following features. In some implementations, the first task includes comparing the second input signal with the third input signal, while in other implementations, the first task includes adding values stored in the second input signal and the third input signal to produce a second output signal. In one implementation, the method includes transmitting the second input signal from the first action block to a condition gate block as a second output signal, and converting the second output signal to a True and False output. In some implementations, the method includes transmitting the True and False output to a second graphical block, and executing an action associated with the second graphical block. In one example, the activation of the switch block further causes the first output signal to be transmitted from the first graphical block to a second action block. In another example, the method includes receiving the first output signal as a second input signal at the second action block, receiving a fourth input signal at the second action block from a second constant block, where the fourth input signal includes a data value that is a constant, and executing a second task associated with the second action block based on the second input signal and the fourth input signal. In some cases, the plurality of graphical blocks further includes a camera block and an image converter block, where an output of the camera block is transmitted to the image converter block via a drawn wire. In one implementation, activation of the switch block further occurs as a result of an interrupting trigger. In another example, activation of the switch block initiates a synchronous execution of tasks associated with each of the first graphical block, a second graphical block, and a third graphical block.

Other systems, methods, features and advantages of the implementations will be, or will become, apparent to one of ordinary skill in the art upon examination of the following figures and detailed description. It is intended that all such additional systems, methods, features and advantages be included within this description and this summary, be within the scope of the implementations, and be protected by the claims herein.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates one implementation of a computer system.

FIG. 2 illustrates an implementation of a graphical programming process.

FIG. 3 illustrates some conceptual differences between graphical programming and text-based programming.

FIG. 4 illustrates one implementation of input, output, input trigger, and output trigger as related to a graphical block.

FIG. 5 illustrates one implementation of the system including three graphical blocks.

FIG. 6 illustrates an implementation of various types of routing and interpreting triggers.

FIG. 7 is a flowchart presenting an implementation of a method for routing between input and output pins of each of the graphical blocks and displaying an online connection failure.

FIG. 8 is a diagram presenting an implementation of input and output data types related to blocks in the graphical programming system.

FIG. 9 illustrates an implementation of a task providing an If-condition clause operation using graphical programming.

FIG. 10 illustrates an implementation of a task providing an If-else-condition operator using graphical programming.

FIG. 11 illustrates an implementation of a task providing a For-statement using graphical programming.

FIG. 12 illustrates an implementation of a task providing a While-statement using graphical programming.

FIG. 13 illustrates an implementation of a stimulation of an Event-statement using graphical programming.

FIG. 14 illustrates an implementation of a multi-event loop using graphical programming.

FIG. 15 illustrates an implementation of a time event loop using graphical programming.

FIG. 16 illustrates an implementation of a task providing a delay loop operation using graphical programming.

FIG. 17 illustrates an implementation of a hybrid drive operator using causality flow programming.

FIG. 18 is a visualization of an implementation of a hierarchical technique using graphical programming.

FIG. 19 is an example of a conversion from one data type to another data type using causality flow programming.

FIG. 20 is a flowchart presenting an implementation of a data type conversion procedure.

FIGS. 21A-21D illustrate various example implementations of graphical programming blocks.

FIG. 22 illustrates instantiated panels structured by causality flow programming routine.

FIGS. 23A-23C illustrate examples of tools implemented in graphical blocks.

FIGS. 24A and 24B illustrate implementations of platforms for a front panel using a graphical program.

FIG. 25 is a block diagram showing an implementation of a computer system.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

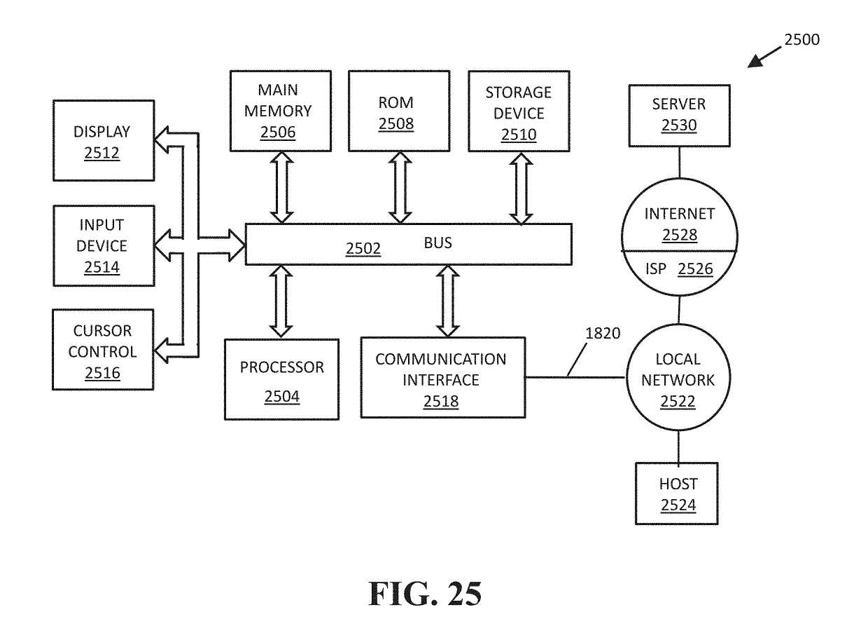

The present disclosure generally relates to a system and method for graphical programming across a variety of computer systems, including new graphical blocks for use with a VPL. The computer system can include personal computers, handheld computers, tablets, laptops, smartphones, mobile devices, embedded systems for certain application, and other devices which utilize a memory or storage unit with access to a processor(s). Further information regarding the computer system will be provided below with respect to FIG. 25. As noted above, graphical programming involves the application of graphical programming blocks to perform specific operations. The graphical programming blocks are converted to machine language and executed. For purposes of this application, graphical programming blocks may also be referred to as “graphical blocks” or more simply as “blocks.”

In one implementation of the proposed programming language, graphics components or icons (or blocks) for each operation are prepared, and a user builds applications via interaction with the specific syntax associated with each component or icon. Various blocks can be configured to be connected by graphical data flow programming, control flow programming, and/or event-driven programming. In some implementations, inputs and outputs of the VPL may be accessed or viewed through an external monitor, keyboard, or GUI (graphical user interface).

Generally, graphical blocks represent an element of graphical programming that include a graphical display and a specific operation or a unique operation relative to other blocks. As noted above, a GUI is one category of user interface, in which the user communicates with a machine or a computer system with the help of ancillary equipment and the use of available graphical icons and markers. In GUIs, inputs or outputs or both might be displayed graphically. In some implementations, a GUI can be associated with the VPL, such that execution of a graphical program can build and/or update a GUI application. Similarly, manipulation of an input-output interface of a GUI can create, build and/or update a corresponding graphical program.

Some terms used in this application are defined as follows. A graphical loop refers to a segment of a programming structure configured to ‘wait’ for an event or message before their task is completed. Graphical loops are conducted by either internal or external sources that are collectively identified as stimulating loop resources. In addition, graphical tasks are defined as smaller units of a graphical program, including graphical blocks, configured to run one or more portions of the program. In one implementation, a graphical task refers to one or more loops associated with different triggers, where the loops are connected to each other in an interdependent manner. Furthermore, data flow programming refers to a programming structure, where the program is executed by defining directed graphs for data that communicates with the operators. Control flow programming is a programming construct that determines and implements grammatical functions based on requirements of the program. Most text-based programming languages such as C++, Java, and Visual Basic programs are implemented via this structure. Event-driven programming is an alternative programming construction, in which the execution flow manipulates the event characteristics to complete tasks. In event-driven programming, the program is initialized, the machine interpreter searches for the input event, and then executes at least one portion of the overall process. In other words, in this type of programming, the sequence of events will control how the individual parts of a program are implemented.

In different implementations, a trigger can refer to a component that represents the beginning of an operation in a graphical block. The trigger may be derived from an internal source within the graphical program. Generally, as an application is executed, an interruption signal will be received, and a reaction occurs per a temporary change in the program procedure. There can be several types of interruption sources in a program, including but not limited to noise, overheated hardware, an alarm state for a process, or even a typed entry by a user. Conventionally, interruptions have been handled through text-based programming, as previous graphical programming procedures cannot fully extract the interruption properties.

In some implementations, an interrupt signal is an indicator of an event outside of the graphical program, which nevertheless affects the decision-making process and implementation of the graphical program. For example, a warning of a temperature sensor for a type of industrial automation, motor control conditions, moving target detection in a dynamic environment, new user connection requests to the Wi-Fi network, and other status changes can be associated with an interrupt signal. There have been significant challenges in running graphical programming routines in view of interrupt signal, one of which has been a lack of coordination between the two processes.

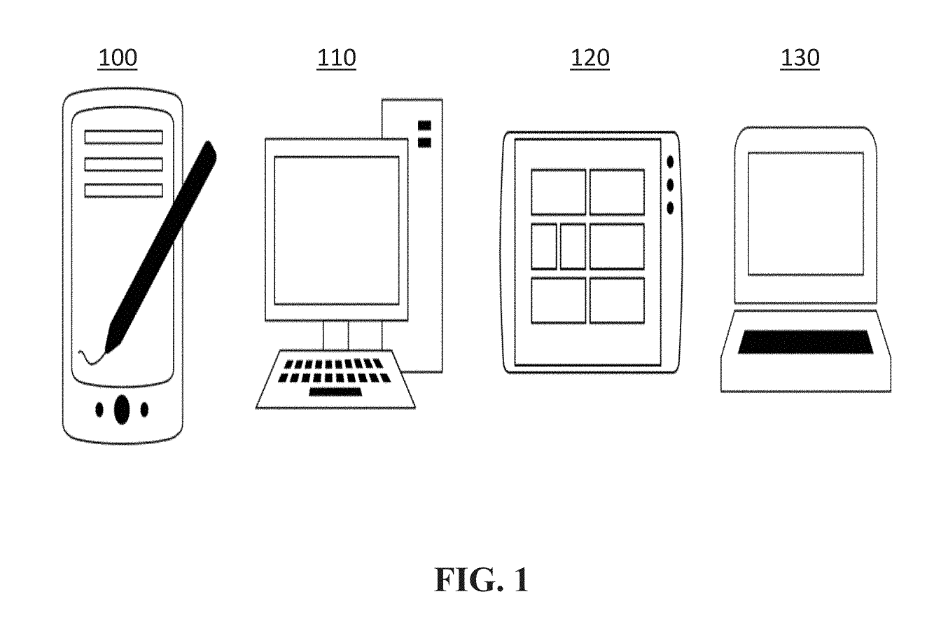

In order to provide a clearer context for the various implementations described herein, FIGS. 1-3 illustrate some examples of a computer system and programming methods. Referring first to FIG. 1, examples of computer systems which are typically used to create, store, and run specific applications of graphical programming are illustrated. As shown in FIG. 1, various types of computer systems are available including a mobile device 100, a desktop computer 110, a tablet 120, and a laptop computer 130. Other computing devices may also be contemplated for use.

In different implementations, in order to build a program, one or more computer systems may work together until the graphical program is translated to machine language. One implementation may include graphical programming elements for use in a system designed for industrial automation, for process control of industrial equipment, or to simulate and investigate the results of processing on a single operator. The present system may also be utilized in the agricultural industry for modeling and controlling of biological processes related to the plants, the development, implementation, and execution capabilities in a wide range of computer systems as hosts, such as the Internet of Things.

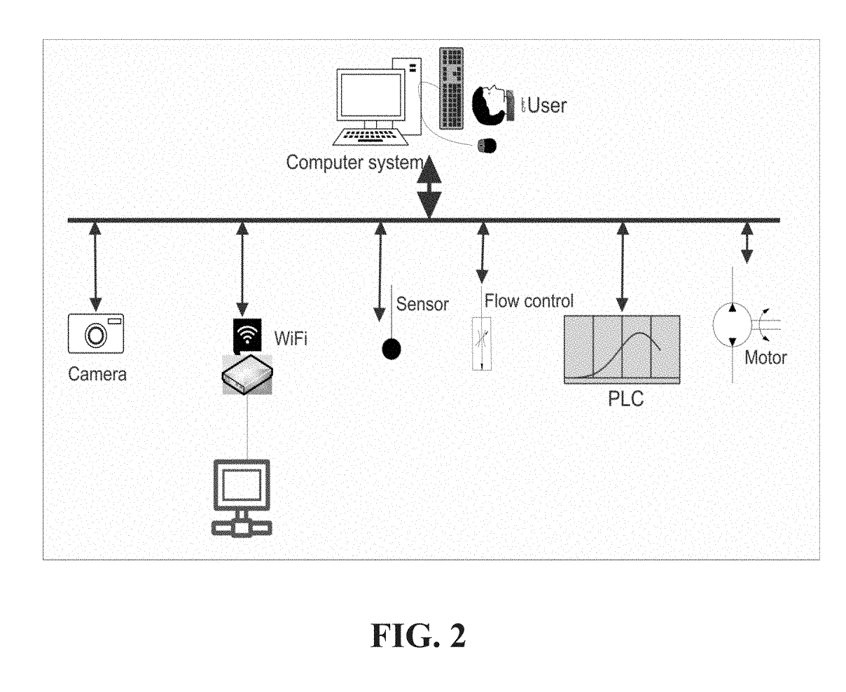

FIG. 2 illustrates one implementation of a graphical programming system. FIG. 2 can be understood to represent an example of a control system for industrial automation, in which a graphical programming procedure is implemented. The system includes a host computer system, which is intended to synchronize the computer system and a number of sensors and control equipment. As an example, a camera can capture photos or a video for storage or further processing via causality flow programming. In addition, Wi-Fi can be used to connect to the network, whose signaling trigger is modeled via graphical blocks. The sensor, flow control, PLC and motors and other equipment, connected to the network interface card or signal conditioning circuits, can impact the graphical program by application of their open trigger signals.

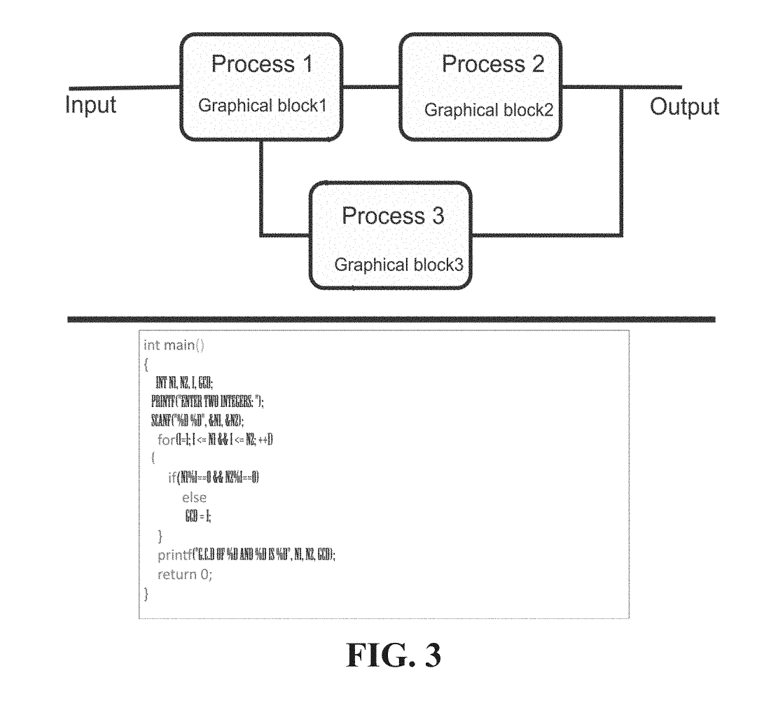

FIG. 3 is a simplified view of a structure of graphical programming (upper half of figure) and text-based language programming (lower half of figure). As illustrated in FIG. 3, the upper diagram includes two graphical processing blocks, where Process 3 is configured as feedback for the entire system.

As noted above, despite the many benefits of graphical programming, its framework as currently available is also associated with several drawbacks. One issue is a determination of the execution procedure of the program, which is generally based on dataflow programming. This structure limits the process of execution, in contrast to solutions offered by text-based programming languages, which is based on control flow programming. Therefore, a structural design compatible with both text-based and graphical programming methods, including the simple design of data flow graphical programming and the flexibility of text-based programming, is a significant aspect of the present disclosure. In different implementations, a structural design based on events and a causal connection between different parts of the program is introduced. In some implementations, trigger inputs of graphical blocks can be positioned next to each block in the form of a pin, or embedded internally in the block.

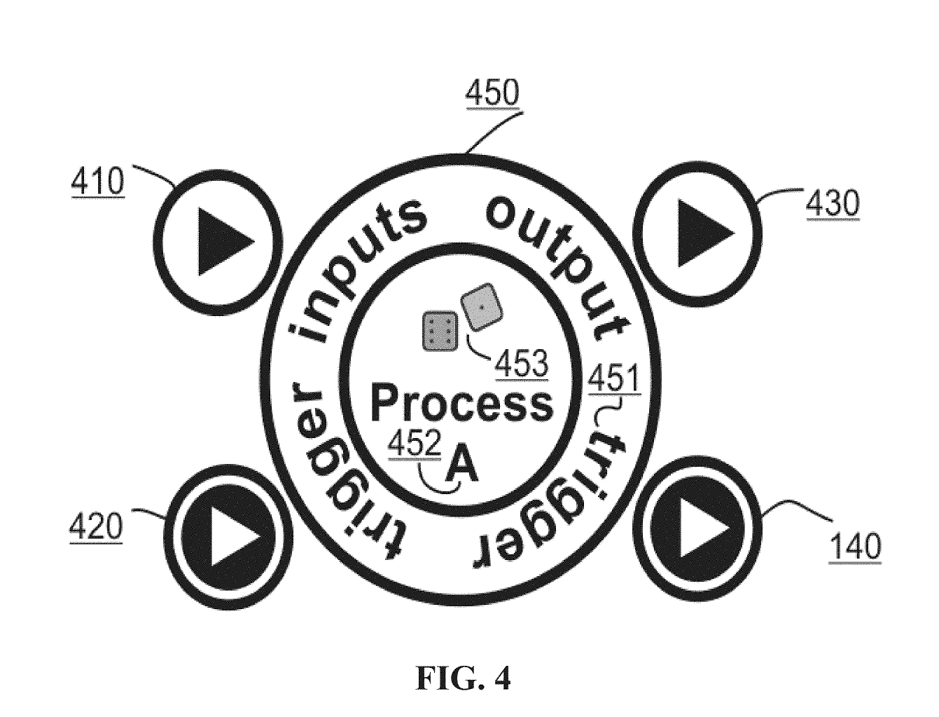

Details regarding this design are presented herein. Beginning with FIG. 4, a schematic diagram (also referred to as a statechart) displaying an input, output, input trigger, and output trigger associated with blocks and a causality flow program in a graphical interface is presented. The graphical blocks are illustrated at a high-level for purposes of clarity. The blocks can be used to perform various processes, including math, signal processing, sensing, data analysis, or switching. In one implementation, a graphical block 450, with an icon 453 and a unique name 452, are depicted. Furthermore, pins of each graphical block are distinguished by text such as text 451.

In different implementations, each block may contain a plurality of inputs 410 and a plurality of outputs 430. The input data type and output data type may be the same type or may differ. For example, as it is possible to process the inputs in a specific manner, the output type is also altered. In addition, inputs 410 for a graphical block are associated with various sources. For example, an input source may originate from external sources such as keyboards, sensors, and other such input devices or components.

In some implementations, an input trigger 420 and an output trigger 440 may also be included. The trigger signal can include a routing trigger or interrupting trigger, which are internal and external source signals, respectively. In one implementation, the input trigger 420 and output trigger 440 can be configured to set up the execution procedure. In such cases, the graphical block 450 will be executed once the input trigger 420 signal is applied to the block; otherwise the block will be disabled. Therefore, in some implementations, the execution procedure of the program is determined based on the priorities identified in the trigger signaling.

As described herein, the proposed implementations alter traditional trends in programming, such as data flow programming (which is based on data input-output relationships), control flow programming (which is executed according to the sequence of the code, and event-driven programming (which is based upon the occurrence of an event in the program). The implementations detailed herein will impact graphical programming paradigms as well as other types of programming paradigms, and help to establish the cause-effect structure. Furthermore, aspects of communication and data flow between the blocks will be described, as well as the trigger command relationship between the blocks.

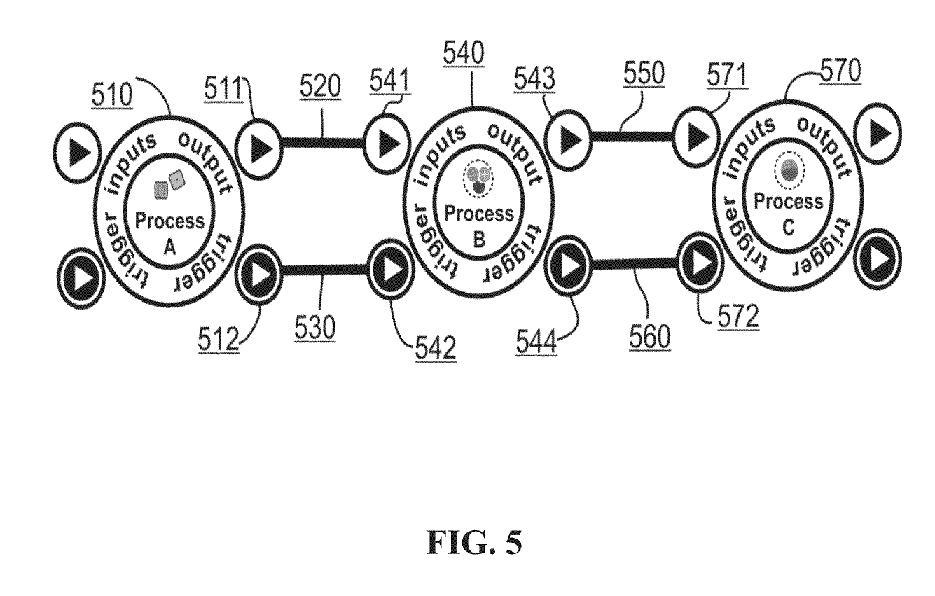

FIG. 5 depicts an example of some relatively simple connections between graphical blocks based on a trigger for graphical programming. The wires between a block A 510, a block B 540 and a block C 570 express an execution order in a graphical program. It can be seen that a trigger pin 512 of block A 510, using a wire 530, is connected to a trigger input pin 542 for block B. The trigger of each graphical block in this case is a routing trigger, because the source of stimulation is another block's output triggers. An input pin 541 of graphical block B 540 is connected to an output pin 511 of graphical block A 510 via a wire 520. Similarly, with respect to block C 570, an input trigger pin 572 is connected via a wire 560 to an output trigger pin 544 of block B 540.

It should be noted that in order to execute the program correctly, data types related to the output pin 511 and input pin 541 are consistent with an output pin 543 and an input pin 571. This avoids the connections between blocks being invalid. In addition, the bootstrap property is utilized for the implementation of block A 510, and determines the starting point of block A 510. This structure helps programs with one or more defined and controlled starting points. In addition, it is possible to obtain different starting points for achieving disparate states in a graphical program.

In FIG. 5, it can be understood that the execution order follows the causality flow. Thus block A 510, block B 540, and block C 570 are executed sequentially, such that, if graphical block A 510 fulfills its processing tasks, the signal associated with trigger pin 512 will be sent to block B 540 using wire 530. Similarly, once the current processing duty is accomplished in block B 540, the program will be executed accordingly, and a signal may be sent to block C 570.

The paradigm of FIG. 5 presents advantages in parallel processing. For example, after the execution thread of block A 510 is completed, block B 540 is stimulated. When a trigger signal is sent again to block A 510, while the previous execution thread has not yet completed, another thread is created to execute data processing either in parallel or in series, depending on the settings of the block. Similarly, the process will be applied to the entire program, in such a way that a structure for executing multi-threads is clear.

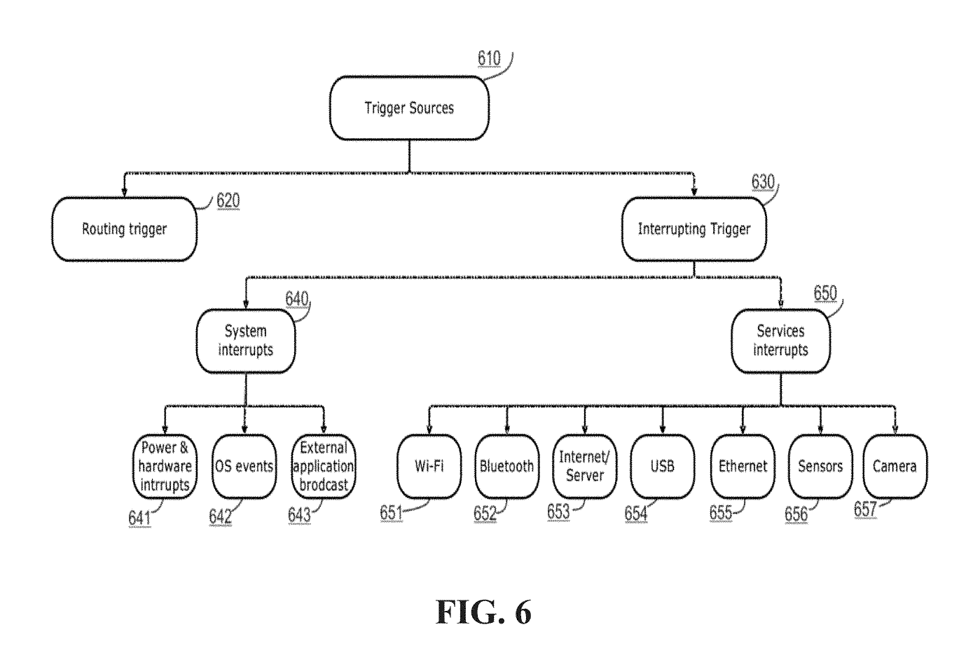

FIG. 6 is a diagram of one implementation presenting various trigger sources. These trigger sources are applicable to the graphical blocks (input trigger 420) of FIG. 4 and the nodes (for example, block B 540 and input trigger pin 572) of FIG. 5. It should be understood that the diagram of FIG. 6 is an example and the trigger sources are not limited to those listed. Moreover, other elements or aspects of trigger sources have been omitted for simplicity.

In different implementations, a trigger can fall under one of two general categories, including a routing trigger 620 which occurs between internal blocks, and an interrupting trigger 630 which occurs as a result of external factors. Other categories can also be available, but for purposes of simplicity only two are discussed here. The routing trigger 620 can be generated or created by internal signals within a graphical program. One routing trigger, such as the wire 530 in FIG. 5, can be seen to connect the output trigger of block A 510 to the input trigger of block B 540.

On the other hand, the interrupting trigger 630 corresponds to sources not present in the graphical program. In other words, the interrupting trigger is generally attributed to instructions associated with an external environment of the internal routing structure of the program. In different implementations, the interrupting trigger 630 includes a vast range of events, either independent or dependent. There are two general resources generating this type of signal, including a system interrupt 640 and s service interrupt 650. System interrupt resources occur in conjunction with computer system events, such as power and hardware interrupts 641, events of operating systems 642, and external software 643. Users typically have little or no control over these types of interrupts.

As shown in the diagram of FIG. 6, service interrupts 650 include services provided for the experience or benefit of the user. Some services, such as Wi-Fi 651, Bluetooth 652, Internet Server 653, USB connection 654 and Ethernet 655 are configured to facilitate user connections, and offer bilateral combinations to exchange information. Another type of service is related to information obtained from the environment to perform secondary processing, including but not limited to sensors communications 657 and cameras 656.

Thus, a computer system, which stores, compiles, and executes the graphical program, may communicate with other components or surroundings (including but not limited to other software, hardware components, and sensors). For instance, the input trigger 420 of the graphical block in FIG. 4 can potentially include any of triggers presented in FIG. 6, which may simplify the programming challenges and generalize the embodiments associated with the application. Additionally, it should be noted that a block can contain any number of trigger inputs and trigger outputs with a variety of sources including both interrupt triggers and routing triggers.

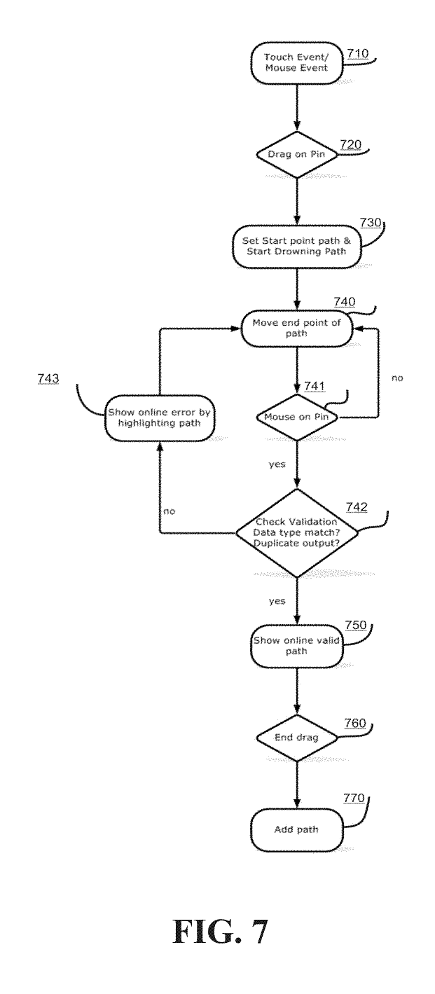

FIG. 7 is a flow chart presenting a method of a graphical drag and drop routine including the wire, the input-output connections, and trigger communication, in the graphical blocks, along with mismatch error representation. This method can be applicable to all computer systems which work with a mouse or touchscreen. The algorithm is executed as described below.

In a first step, a graphical program is created in the memory source and, after placing the graphical blocks in the integrated development environment, the connection between the blocks is established. Using a mouse or touch screen 710, a pin 720 is drawn in a second step. Pin 720 may include an input, output, input trigger, or output trigger. Moreover, in some implementations, a limitation in drawing the graphical wire is related to the compatibility between a beginning and an end of the drawing.

In a third step, drawing the graphical wire is initialized to begin 730. Because each wire will reach a stage 740 (fourth step) of the graphical block, the previous conditions are checked before finalizing the drawing. Next, once the wire is situated at an end pin 741 in a fifth step, the validation process is examined in a condition 742 (sixth step), and may entail a reevaluation of stage 740 (seventh step). Once condition 742 has been verified, the validation 750 is illustrated online as an eighth step. However, the procedure will return to the stage 740 in the event of a false condition result. Finally, in a ninth step, the drag ends 760, and a drawing process 770 occurs in a tenth step.

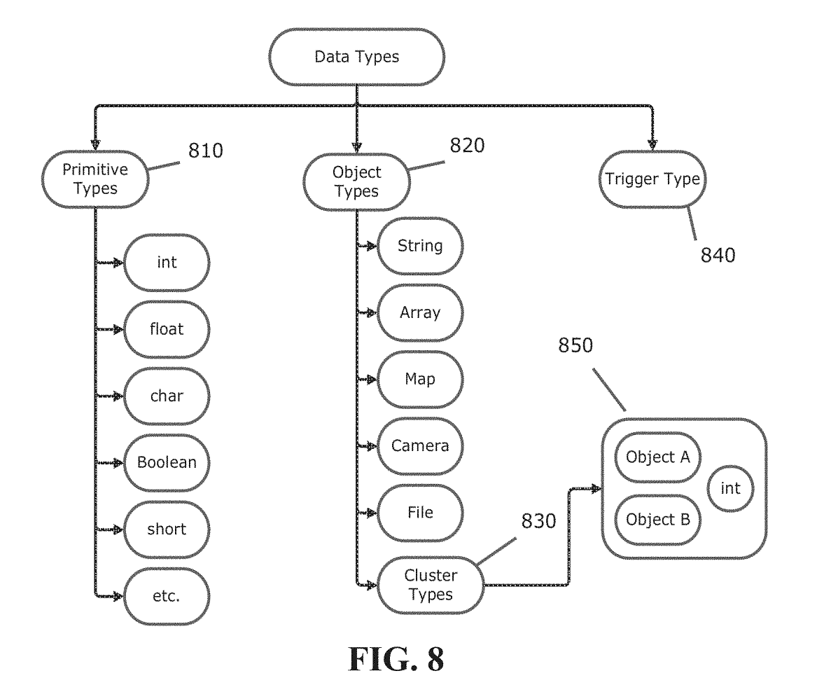

Next, FIG. 8 depicts a diagram of one implementation of different types of input and output data sources which can be used in graphical blocks. It should be understood that the graphical blocks are not limited to those types of data listed in FIG. 8. Additional sources have been removed for purposes of clarity.

In different implementations, the data types of FIG. 8 may generally fall under one of three categories, including a Primitive type 810, an Object type 820, and a Trigger type 840. The Primitive type 810 includes basic format, such as int (integr), char (character), float (numbers having decimals), double (numbers having decimals), String (collection of characters) and/or Boolean (true or false). Primitive type formats are typically found in all text-based programming constructs such as C++ and Java.

Meanwhile, Object type 820 includes data associated with a higher layer relative to the Primitive type 810, which is associated with a larger data and with extensive range. For instance, strings and arrays are Object type 820 data collections, which may be candidates for an output of a graphical block. Other object types of data can be derived from particular outputs, such as Map, Camera, or File, and contain raw data but also include information that can be used according to the specific application. A data format is a cluster type 830 that comprises some object and primitive data 850. The third category of data is Trigger type 840, which was discussed previously with respect to FIG. 6, and includes the routing trigger 610 and the interrupting trigger 620.

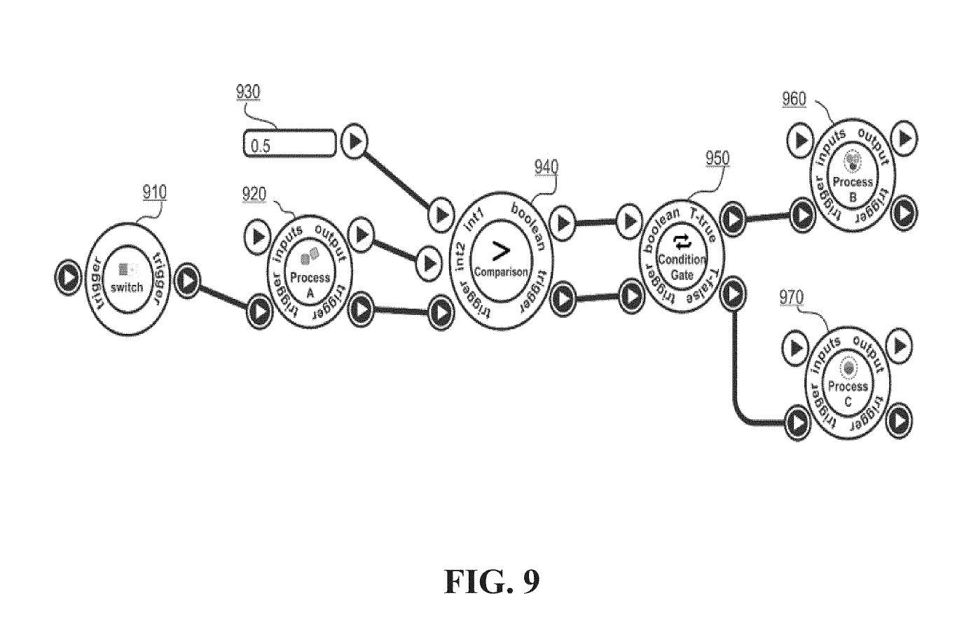

FIG. 9 illustrates graphical tasks that can be performed when using graphical blocks, where the structure follows trigger flow programming. According to FIG. 9, the task of a switch 910 is stimulation of the trigger. Immediately after the switch is clicked or touched, it performs a stimulation, such that the input of graphical block A 920 is activated, and input data using the previous output is transferred to a comparison block 940, sequentially.

Furthermore, comparison block 940 is connected to a constant block 930, which is set to 0.5. The trigger output for block A 920 is wired to trigger input pins of the comparison block 940. Following manipulation of the trigger signal to the comparison block 940, the comparison is fulfilled, in which case the trigger output pin and its output are sent to condition gate block 950. The converted True and False Trigger outputs are transmitted, and consequently, block B 960 and block C 970 with True and False indications are implemented in terms of executing conditions.

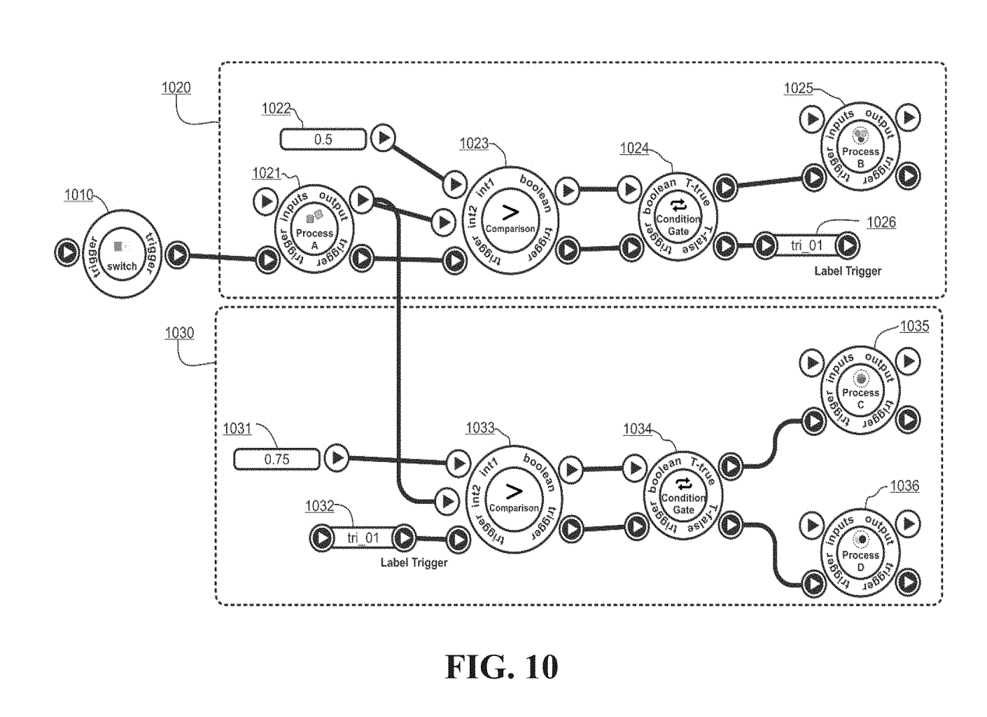

FIG. 10 illustrates an expanded implementation of FIG. 9, where a trigger stimulation switch 1010 is configured to activate a block A 1021. The first portion of a Condition stage 1020 is similar to that of the if-condition in FIG. 9, though in this case the false trigger output in a Condition Gate 1024 block is connected from a pin 1026 to a pin 1032. As a result, the false output trigger of the Condition Gate 1024 stimulates a Comparison 1033 block. It should be noted that the blocks presented graphically in FIG. 10 can be expanded to include other blocks and additional conditional instructions.

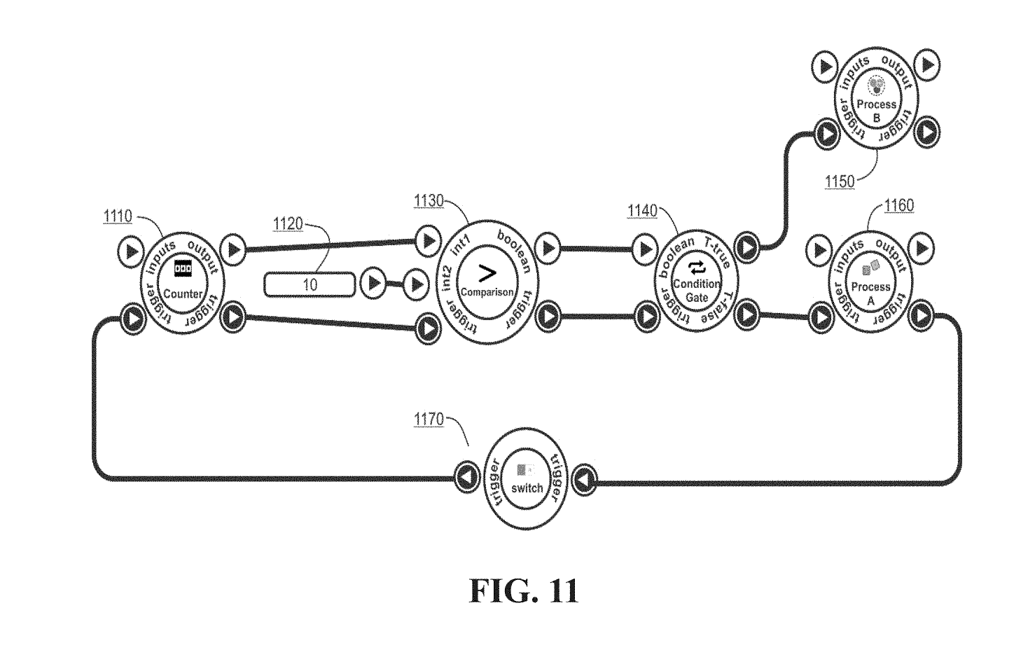

Referring next to FIG. 11, a switch 1170 has the task of stimulating a trigger, either by clicking or self-stimulation. By stimulating a counter block 1110, the previous value is added by one to produce a new value in the output. The counter block 1110 can obtain its initial value by either an input or an internal configuration. The output trigger of the counter block 1110 also stimulates a comparison block 1130. The new input in comparison block 1130 is compared with a fixed amount 1120. The results will be sent to condition gate block 1140, which is configured to stimulate, based on the false or true output, a block A 1160 and block B 1150.

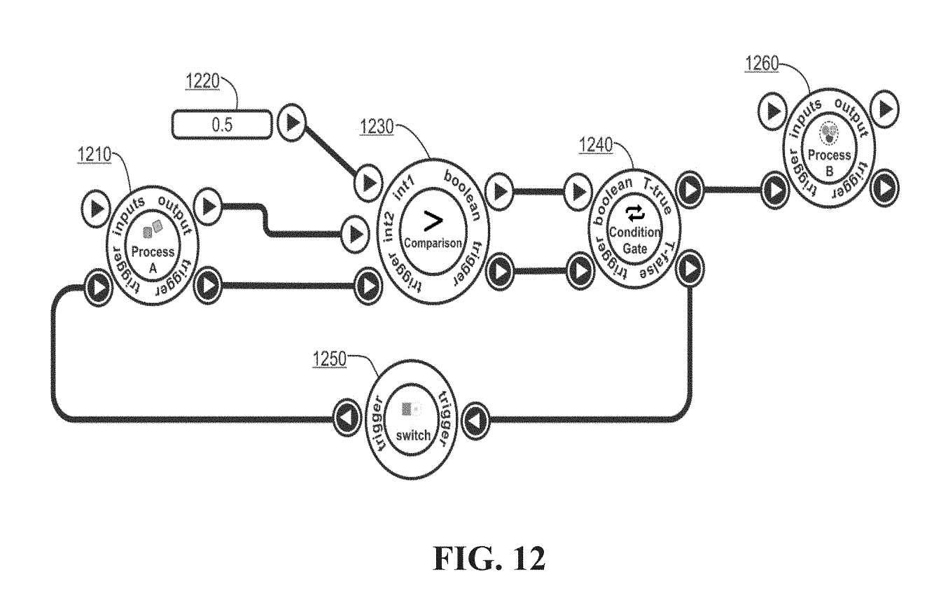

In FIG. 12, a while-loop for a graphical program using the trigger flow framework is illustrated. Block A 1210 acquires its input values from other blocks not shown in the figure, and a switch 1250 is activated by a stimulating trigger. The output and trigger output are then delivered as input and trigger input for a comparison block 1230, respectively. Moreover, additional input of a comparison block 1230 is initialized by a constant block 1220. Thus, if the second input value of the comparison block 1230 is less than the first input, a block B 1260 is triggered by a graphic block condition gate 1240. If the second input value of the comparison block 1230 is not less than the first input, the while loop is executed, and input trigger of the switch 1250 and subsequently, the input trigger of block A 1210, are stimulated. The figure depicted is a simple case of the while-loop with which the implementation of more complex operations of a while-loop can also be performed.

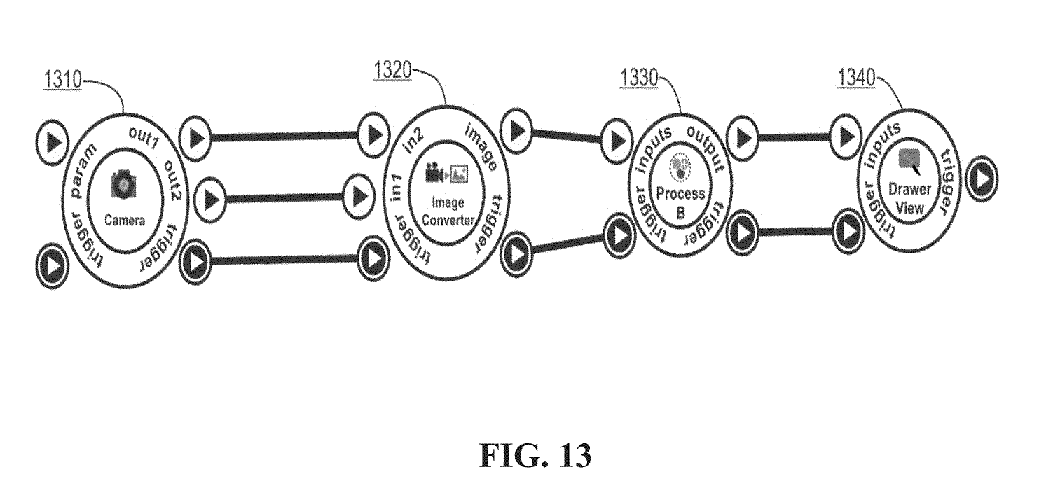

Referring next to FIG. 13, an implementation of a task applying trigger flow programming to achieve an event-loop is illustrated. A camera block 1310, which is associated with the computer system, captures images and prepares the images for transmission to the output pin for each receiving data. The output data and triggers of the camera block 1310 are conveyed to an input and a trigger input pin of an image converter block 1320 via drawn wires. In one implementation, the camera block 1310 is stimulated by the hardware system, and the trigger is an interrupt type. The stimulation results from an external source rather than a local graphical block. In addition, the trigger between the camera block 1310 and the image converter block 1320 is a routing trigger. The image converter block 1320 is linked with block B 1330, by which the processing of the image is accomplished. Finally, the output values are sent to a monitoring block 1340 to be displayed.

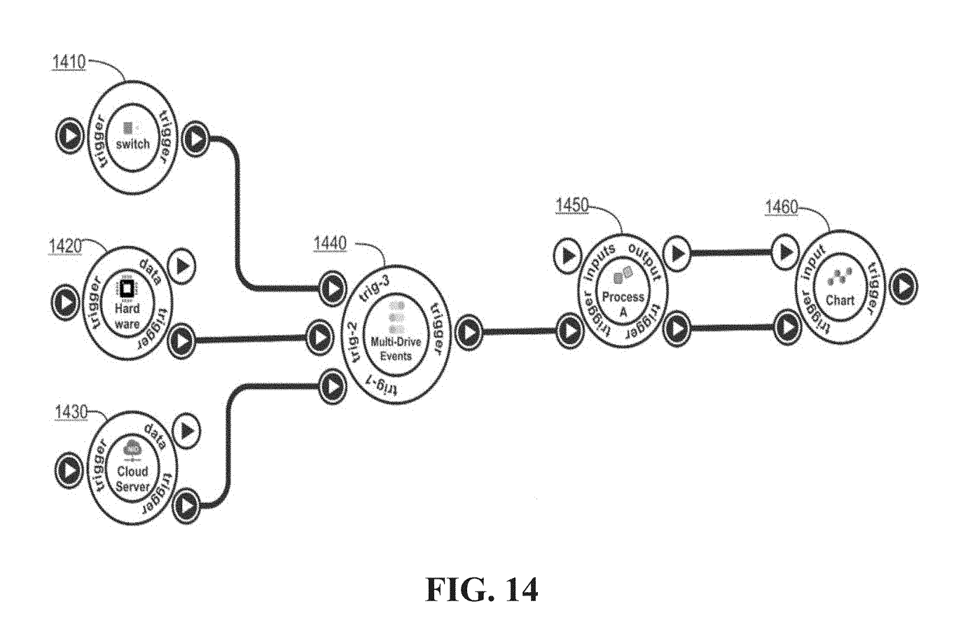

In FIG. 14, a multi-event loop using graphical programming blocks and trigger flow programming is shown. In this figure, a switch block 1410, a hardware block 1420 and a cloud server 1430 serve different tasks and work independently. Interrupting triggers serve as triggers of the internal system, and routing triggers area configured to connect the stated blocks (switch block 1410, hardware block 1420, and cloud server 1430) to a multi-drive event block 1440. According to the reasonable definition made in the multi-drive event block 1440, a logical combination of received triggers will create a trigger command in the output of this block. Subsequently, the stimulation signal will enter a processing block A 1450, and the results are displayed on a chart 1460. One of the concepts presented by trigger flow programming is that of controlling the benchmark which is of great importance in signal and image processing, made up by a reasonable combination of other blocks.

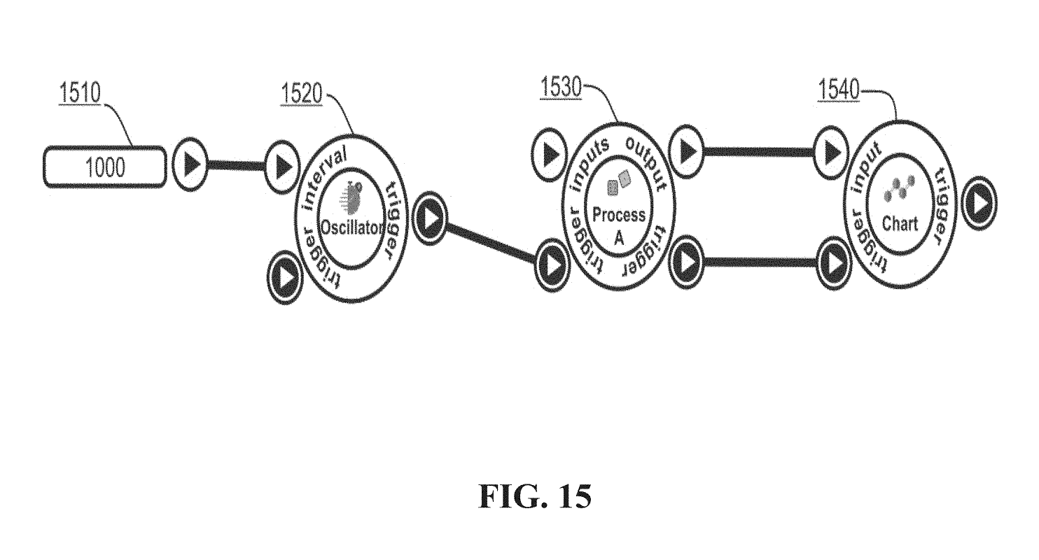

FIG. 15 is a representation of a task applying trigger flow programming, which implements a time-event loop at regular intervals. In the paradigm depicted in FIG. 15, a constant block 1510 specifies the constant stimulation intervals by an oscillator block 1520. The output of the oscillator block 1520 is connected by wire to the trigger of Block A 1530, which instructs the processing of block A 1530 to be performed within a specified time period. Using the trigger output of block A 1530, the trigger of a chart block 1540 is stimulated, and consequently the output values of chart block 1530 are displayed.

It should be noted that it is possible to activate one specific process at certain time periods in graphical programming, such that diverse users can coexist in the search system. For example, there may be a search for active users on a network connection using the broadcasting method, in which a pilot signal is transmitted at specific times.

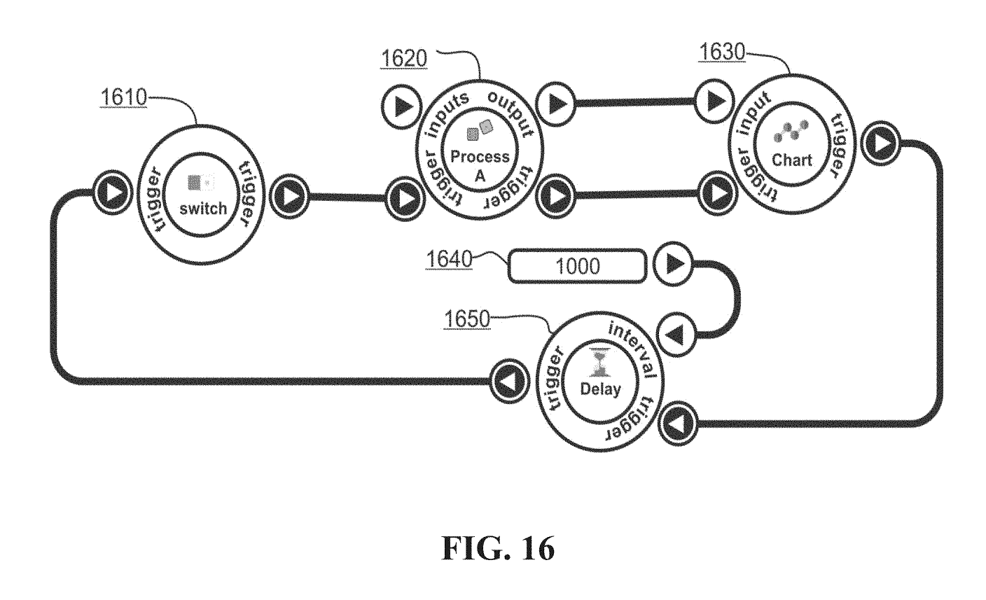

FIG. 16 is a representation of a task including a delay loop which is implemented using trigger flow programming. In FIG. 16, a switch block 1610 is configured as a graphical programming launcher. The trigger of the switch block 1610 stimulates block A 1620, which performs a processing operation. The output and trigger output of block A 1620 are attached to the corresponding input pins of a chart block 1630. Chart block 1630, representing information blocks, is also a stimulating factor of a delay block 1650. In addition, the delay block 1650 leads to a trigger of the switch block 1610, through delays proportional to the fixed amount of block 1640. FIG. 16 can be understood to illustrate a relatively simple sample of feedback control systems described herein.

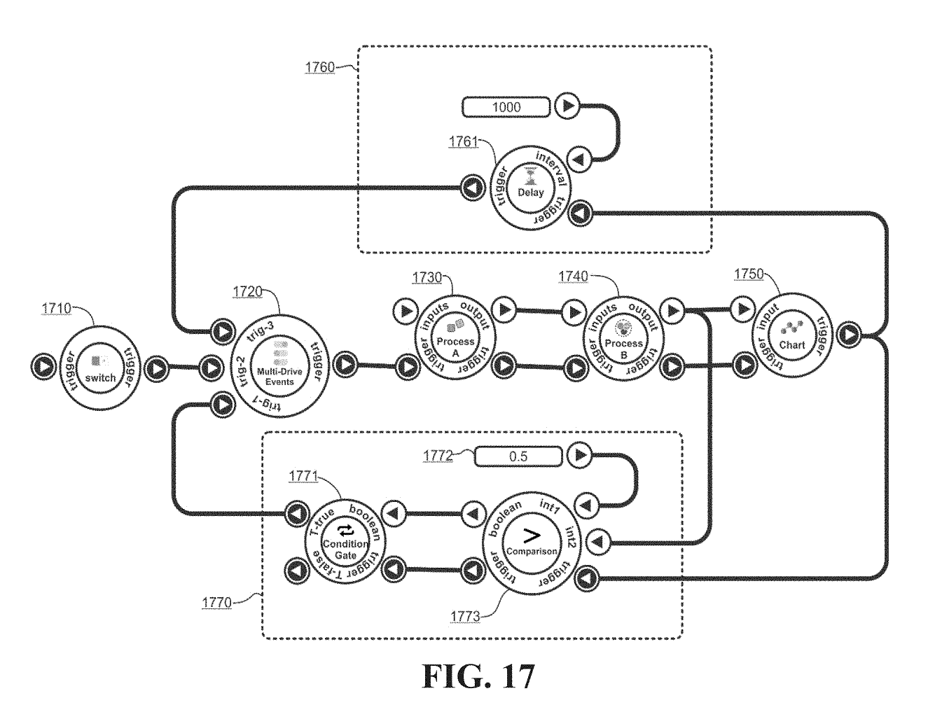

Referring now to FIG. 17, a representation of a multi-stimulating combinations of different graphical blocks is shown, where use of a hybrid drive graphical block occurs in conjunction with trigger flow programming. The dotted lines in FIG. 17 more distinctly separate different sections for purposes of clarity of viewing. A switch block 1710 represents a trigger switch, which has the task of prompting the program. A multi-drive event block 1720, whose input and output are trigger signals, has three input types including switch block 1710, a delayed feedback loop 1760, and a conditional feedback loop 1770. Once the switch 1710 is verified or checked, an output trigger stimulates the multi-drive event 1720. The output of this block is a trigger signal, which launches processing block A 1730, and finally, the output of block A 1730 is provided to block B 1740.

Furthermore, the trigger output of Block B 1740 stimulates a graphical chart display block 1750. In addition, the trigger output of chart block 1750 simultaneously stimulates a delay block 1761 and a condition block 1773. The trigger outputs of the delay feedback loop 1760 and the conditional feedback loop 1770 are connected to the inputs of the multi-event drive block 1720, where each of the triggers has the capability to trigger these blocks. This example illustrates a means by which a controllable graphical block can be used by programmers to perform increasingly complex processes.

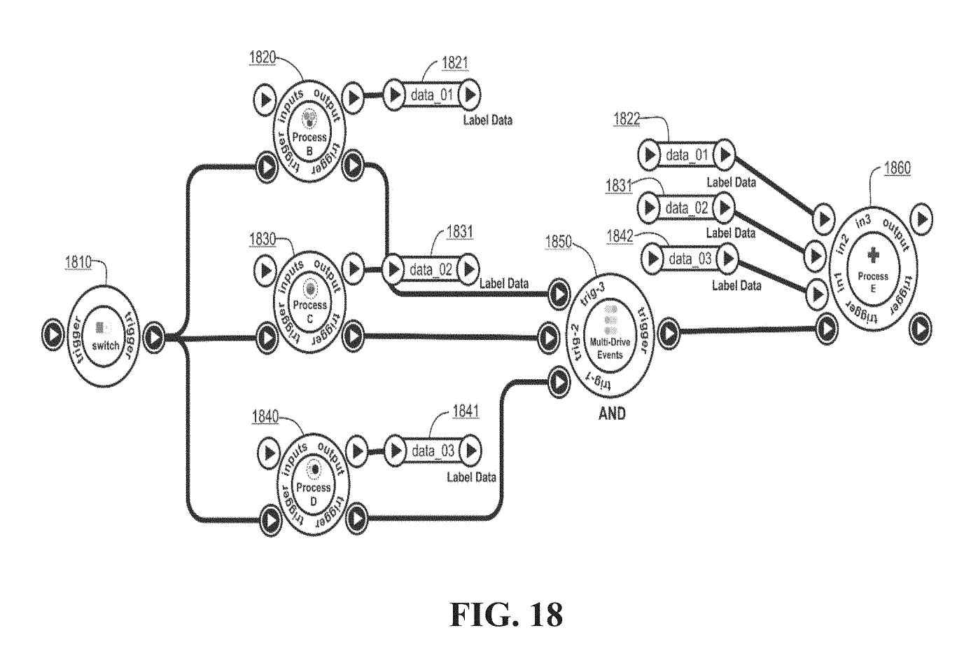

FIG. 18 presents an example of a plan for the implementation of three different processes capable of multi-threading. In this structure, following stimulation of a switch block 1810, and thereby initiate synchronous processing of block B 1820, block C 1830, and block D 1830, such that three separate threads are created. A multi-drive event block 1850 applies the logic operations on the three-input AND of its own stimulation inputs by default. Thus, at least each of the input pins should be stimulated once to activate the trigger output. After the processing of each of block B 1820, block C 1830, and block D 1830 is completed, a command is sent to the trigger of block E 1860. In this structure, three processing procedures are performed in parallel and, depending on the preference of the programmer, a sequence of processes can stimulate other processes.

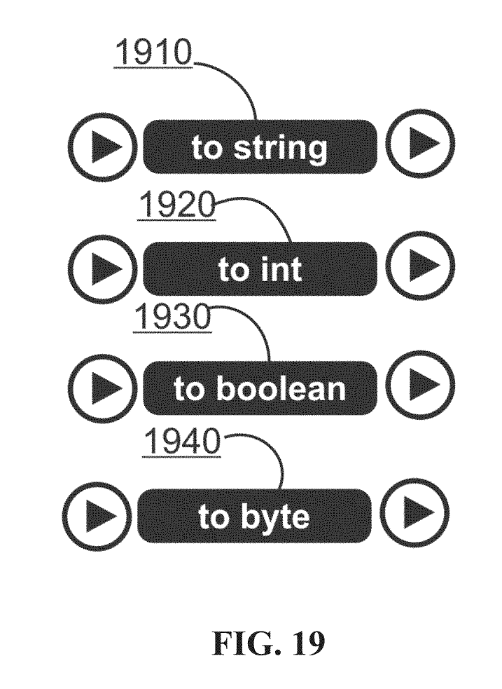

In FIG. 19, structures configured to perform data type conversion from one type to another without a trigger signal are illustrated, in which the desired output is produced as soon as inputs arrived. Note in FIG. 19 that some instances of altering the data type to String 1910, int 1920, Boolean 1930, and Byte 1940 occur. In other implementations, data type conversion can occur among other types of data as well. Once the output of a block does not match with the type of input of other blocks, a similar structure can facilitate the connections. In addition, because there is no need for a trigger, the desired structure is readily implemented.

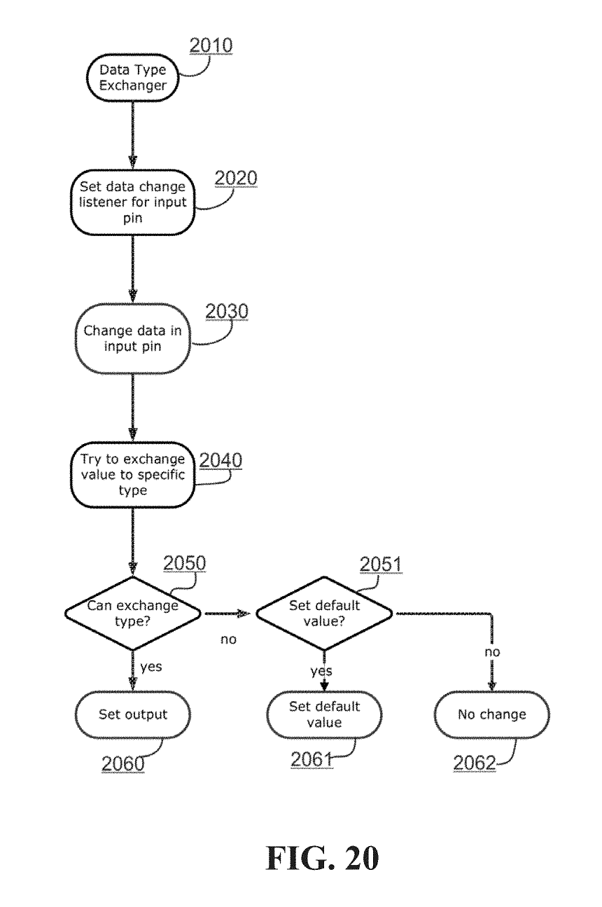

FIG. 20 is a flow chart presenting an implementation of a method of changing a first type of data into a second type of data. In a first step, pins 2010 are responsible for activation of the conversion process. The processor receives input data via pins 2020 and 2030 in a second and third step. Moreover, the output data type is determined or selected. A fourth step involves a pin 2040, in which the processor attempts to alter the incoming data type. The process continues based on a result 2050 in a fifth step. For example, a float to Boolean conversion does not have concrete realization, and Boolean can be converted to double. In the fifth step (result 2050), if the conversion can be performed, the output is initialized in a sixth step 2060. Otherwise, an evaluation of whether there exists any default type occurs in a seventh step 2051. In cases where there is a default type, the value 2061 is set to output in an eighth step. In cases where a default type is absent, the data remains unchanged 2062.

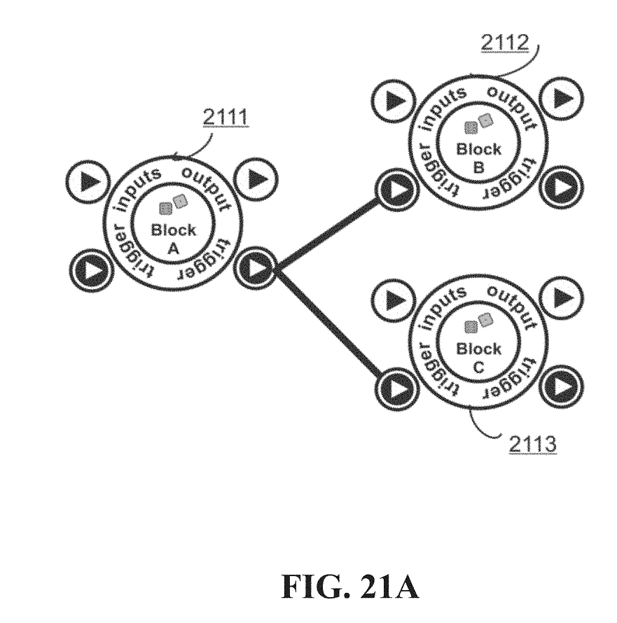

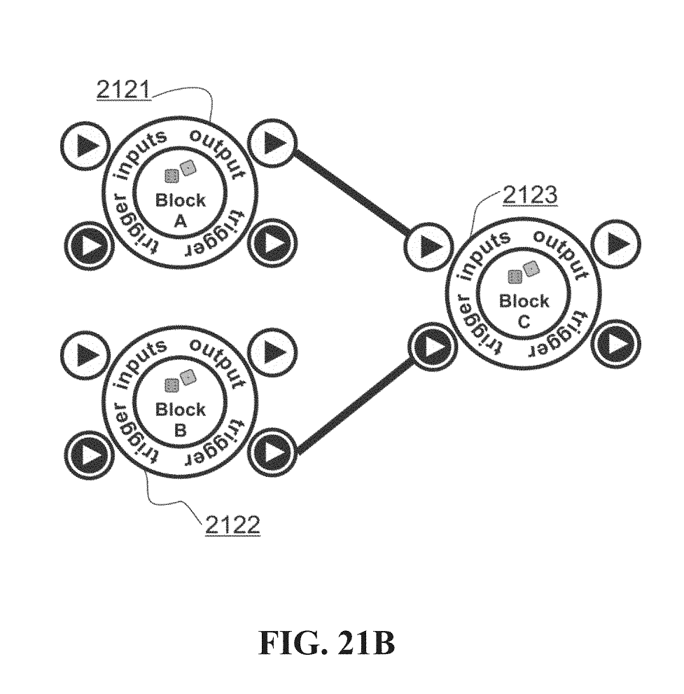

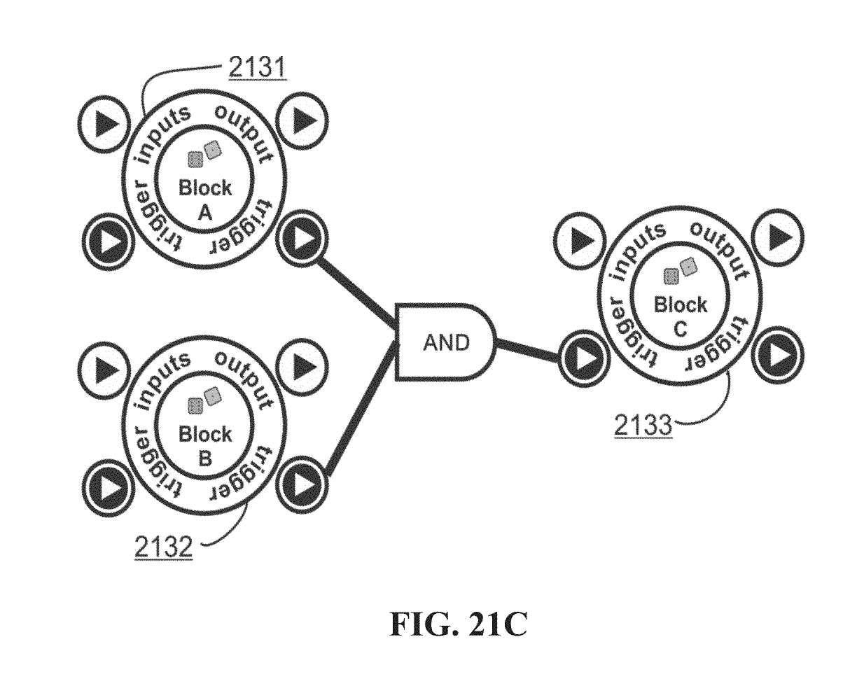

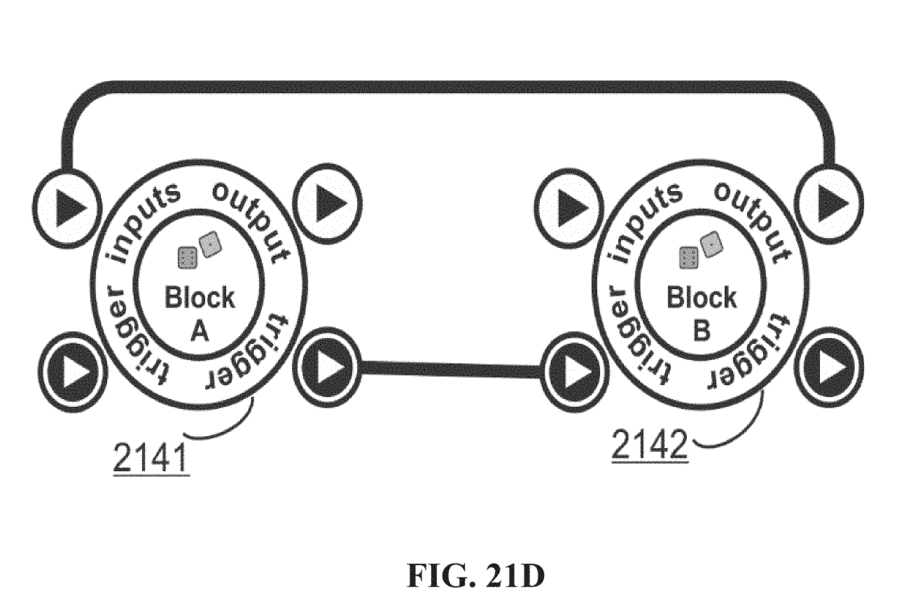

FIG. 21A illustrates a structural capability of trigger flow programming for output trigger programming, where trigger graphical block output A 2111 is simultaneously connected to the trigger inputs of both graphical block B 2112 and graphical block C 2113. It can be seen that trigger flow programming in graphical programs offers a solution for engineers in different fields that can fulfill and control complex processes with various types of inputs and outputs. In different implementations, processes in parallel, series, or a combination of both can be performed. Furthermore, such a process can also be used in other much more complicated processes where the number of blocks in the graphical program is large.

FIG. 21B illustrates another example of structural states for trigger inputs between blocks. In the combination shown in FIG. 21B, a graphical block C 2123 receives the output of block A 2121. However, the trigger output of block B 2122 also stimulates the trigger input of block C 2123. The solutions elicited from this structure enable programmers to stimulate simultaneously using diverse sources of inputs and trigger inputs of a graphical block. For example, block C 2123 will be triggered if a trigger command of the output of block B 2122 is received by block C 2123. Using this kind of structure can facilitate complicated processes (for example, with high rate math operations), where the program does not need to be reprocessed when a few inputs are altered, provided that its trigger is active. This benchmark may be applied by connecting wires associated with each process to each other, resulting in optimal use of resources in the CPU and memory.

FIG. 21C shows an example of different combinations among trigger connections of a graphical block. In one implementation, the system may be used to trigger signaling for each graphical block, leading to a programming design using causality flow programming. One of the benefits of such a structure is that wide variety of different combinations, which are not feasible on currently available graphical programming software, may now be realized. In FIG. 21C, complex logical operations of various trigger inputs help construct the trigger signaling. The output of this block is wired graphically to input triggers of block C 2133. Block C 2133 switches to a stimulation state when both trigger inputs are triggered at the same time. Thus, activation directly corresponds with some blocks in some implementations. For example, in industrial automation, there may be a system with numerous sensors dependent on other controllers and sensors, and such a system may be easily implementable using this structure.

FIG. 21D illustrates an example of different combinations of connected inputs and outputs being used as feedback model. One proposed combination is depicted in FIG. 21D, in which the input of a graphical block A 2141 is connected or attached to the input of block B 2142, while the output trigger of Block A 2141 is stimulated by the input trigger of Block B 2142. This structure illustrates a feedback based model in which the input and output of blocks are interdependent. This implementation offers a simple solution for complicated processes, such as closed loop controlling systems, which are highly vulnerable to instability. Provisions associated with runtime of feedback processes with interdependent components can be essential. Moreover, additional graphical blocks may be added between block A and B of the structure of FIG. 21D. Furthermore, such a programming paradigm can be applied not only to graphical programming, but also in other programming paradigms, including text-based languages, to control physical processes feedback.

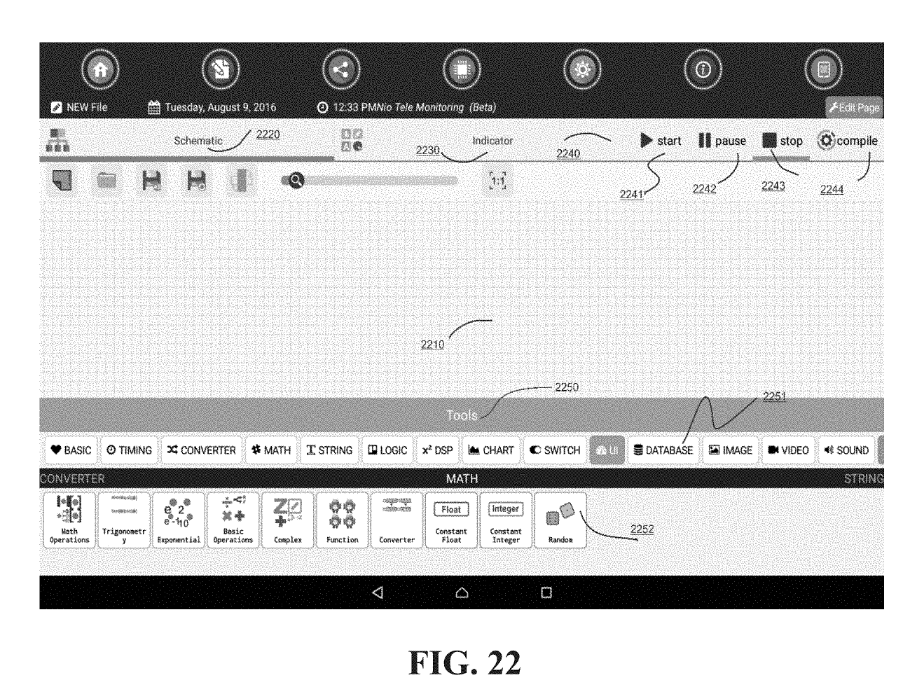

FIG. 22 is an example of a screenshot with a development environment based on the implementations described using causality based programming. As illustrated in FIG. 22, graphical blocks for use in the graphical program are placed in area 2210. As discussed with respect to FIGS. 4, 5 and 6, the connections are implemented by wires. Such development environment programming based on causality flow programming helps define the graphical presentations for blocks, such as schematic 2220 and Indicator 2230. As described with respect to the visualization depicted in FIG. 4, the graphical blocks produce the structure of the program which includes a comprehensive range of functional blocks. These blocks 2251 in the environment can be accessed by use of different graphical menu tools 2250. As an example, menus 2240, start 2241, pause 2242, stop 2243 and compile 2244 are represented. Each of the above menus are configured for a particular application.

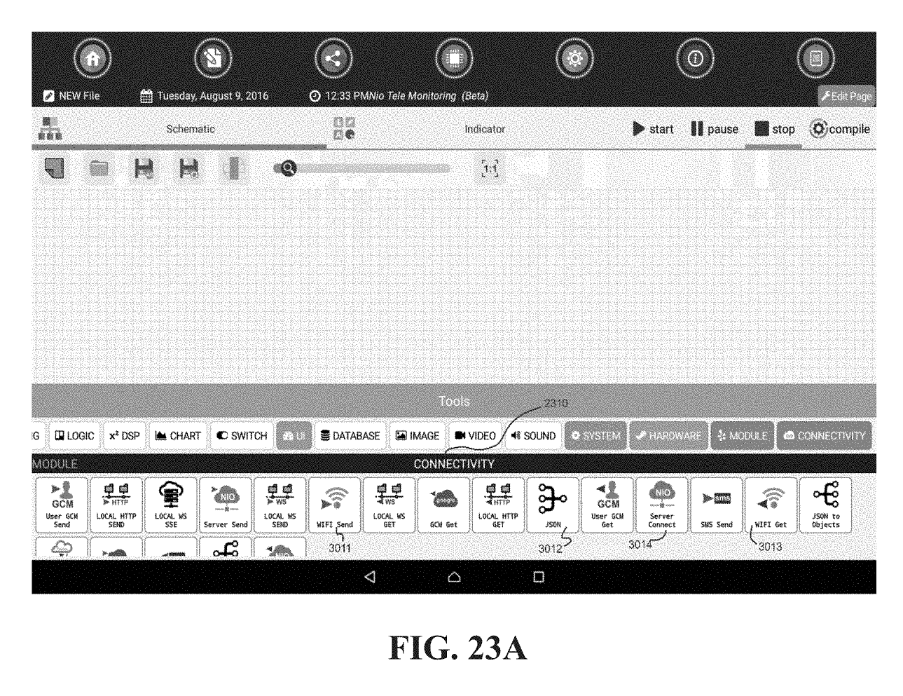

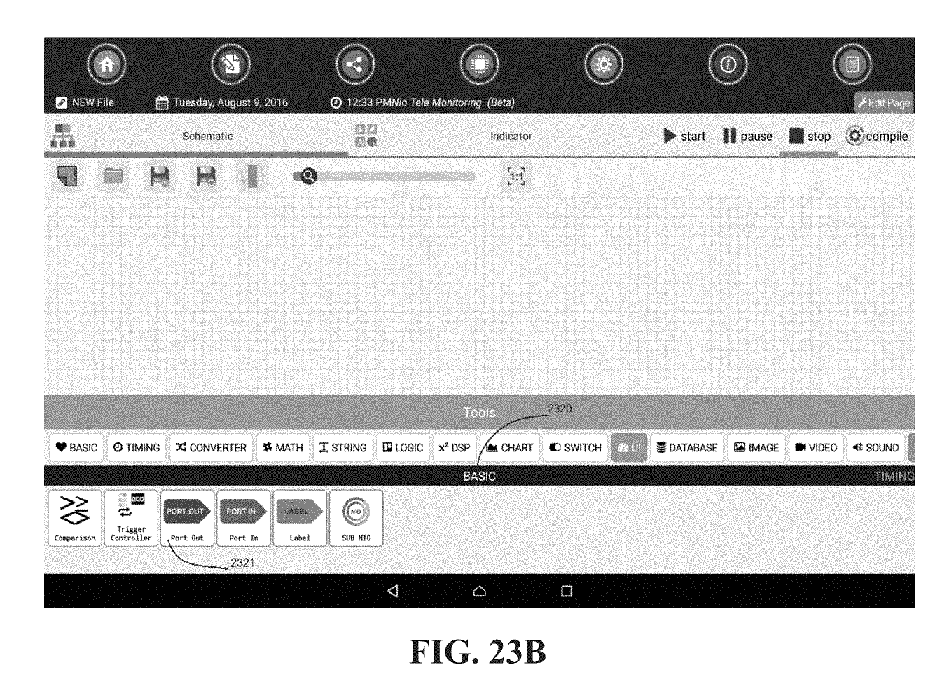

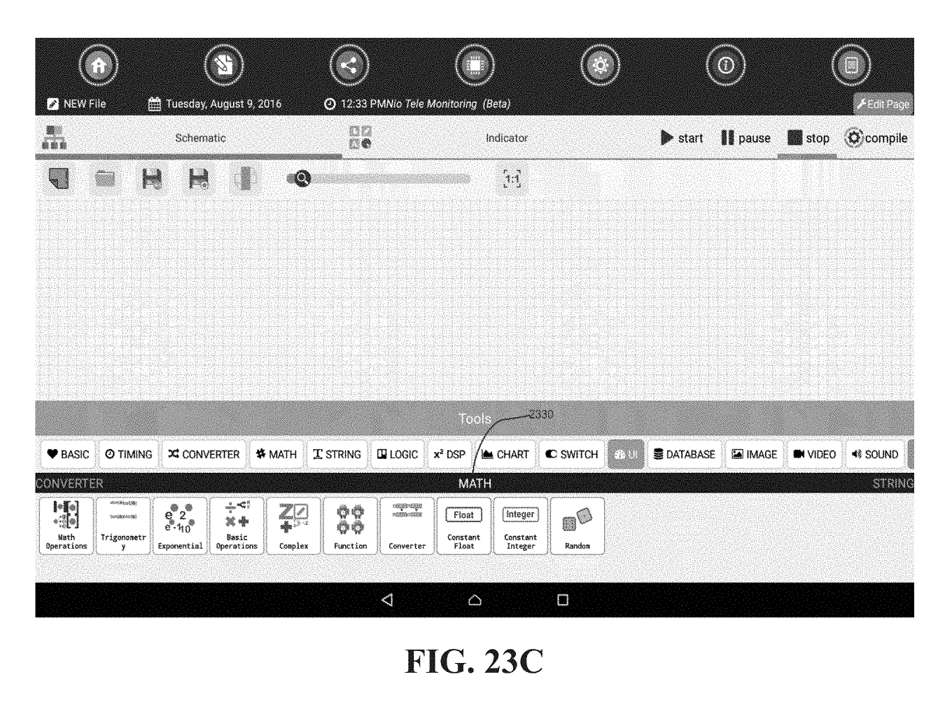

FIG. 23A illustrates an example of a connectivity module 2310, which includes several design considerations. For example, transmission via Wi-Fi 3011, JSON 2312, and/or a server connection may be used for cloud computing. FIG. 23B shows an example of basic graphical blocks 2320 using causality based programming. In this figure, blocks representing an input port and an output port 2321 are embedded for basic tasks in graphical programming. In FIG. 23C, arithmetic operations 2330 such as mathematical comparisons, exponential transformation, functions, and others, are offered. As illustrated, all of the processes necessary for programming can be realized by the algorithms and systems suggested in this system.

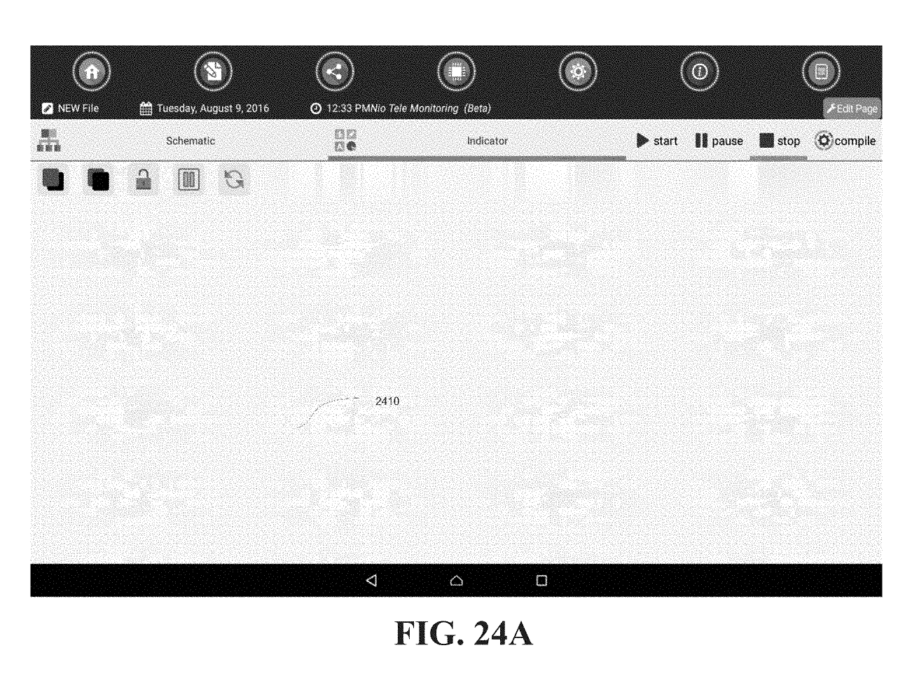

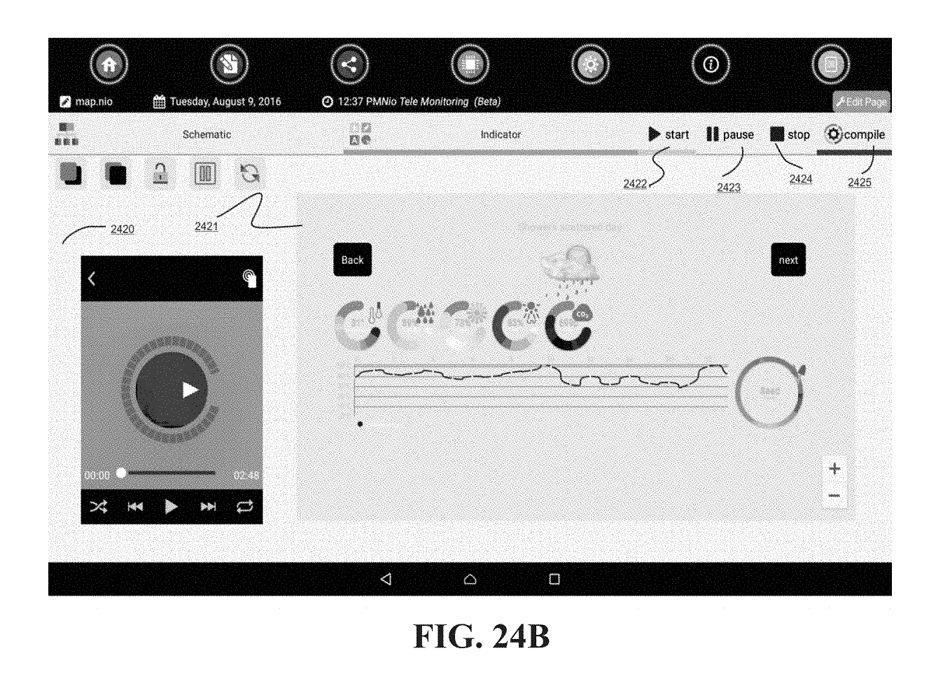

FIGS. 24A and 24B depict user interface screenshots with graphical program elements for application in causality flow programming. In FIG. 24A, area 2410 shows an empty graphical interface, in a state before compilation of a program designed in a graphical development environment. In FIG. 24B, area 2420 illustrates the same graphical environment when the application is running. Icon 2421 is a simple display of a graphical application that is used to regulate greenhouse conditions. Using a start 2422, pause 2423, stop 2424, and compile 2425 menus, an execution environment can be controlled and debugged.

In different implementations, the implementations described herein may be configured to permit entry of definitions of one or more starting points for a graphical block. For example, a bootstrap may be applied before execution of the program. Furthermore, the concept of “Causality” can permit the design of complex applications with a large number of inputs and outputs to provide optimal management of resources and improve the effectiveness and efficiency of associated processes.

As described above, the various graphical program structures and model can be provided through computer processors and software. Thus, the implementations described herein can be easily accessible in standard computing devices. FIG. 25 is a block diagram showing a computer system 2500 upon which aspects of this disclosure may be implemented. Computer system 2500 includes a bus 2502 or other communication mechanism for communicating information, and a processor 2504 coupled with bus 2502 for processing information. Computer system 2500 also includes a main memory 2506, such as a random access memory (RAM) or other dynamic storage device, coupled to bus 2502 for storing information and instructions to be executed by processor 2504. Main memory 2506 also may be used for storing temporary variables or other intermediate information during execution of instructions to be executed by processor 2504.

The computer system 2500 can implement, for example, one or more of, or portions of the modules and other component blocks included in the system illustrated in FIGS. 1-24. The computer system 2500 can also implement, for example, one or more of, all or portions of each of the operations illustrated in FIGS. 1-24. All calculations described herein may also be performed or implemented by computer system 2500.

Computer system 2500 can further include a read only memory (ROM) 2508 or other static storage device coupled to bus 2502 for storing static information and instructions for processor 2504. A storage device 2510, such as a flash or other non-volatile memory can be coupled to bus 2502 for storing information and instructions.

Computer system 2500 may be coupled via bus 2502 to a display 2512, such as a liquid crystal display (LCD), for displaying information, for example, associated with the input or output parameters or other simulation information. One or more user input devices, such as the example user input device 2514 can be coupled to bus 2502, and can be configured for receiving various user inputs, such as user command selections and communicating these to processor 2504, or to a main memory 2506. The user input device 2514 can include physical structure, or virtual implementation, or both, providing user input modes or options, for controlling, for example, a cursor, visible to a user through display 2512 or through other techniques, and such modes or operations can include, for example virtual mouse, trackball, or cursor direction keys.

The computer system 2500 can include respective resources of processor 2504 executing, in an overlapping or interleaved manner, multiple module-related instruction sets to provide a plurality of modules to implement the processes illustrated in FIGS. 1-28 as respective resources of the processor 2504 executing respective module instructions. Instructions may be read into main memory 2506 from another machine-readable medium, such as storage device 2510.

In some examples, hard-wired circuitry may be used in place of or in combination with software instructions to implement one or more of the modules or operations or processes illustrated in FIGS. 1-24.

The term “machine-readable medium” as used herein refers to any medium that participates in providing data that causes a machine to operate in a specific fashion. Such a medium may take forms, including but not limited to, non-volatile media, volatile media, and transmission media. Non-volatile media can include, for example, optical or magnetic disks, such as storage device 2510. Transmission media can include optical paths, or electrical or acoustic signal propagation paths, and can include acoustic or light waves, such as those generated during radio-wave and infra-red data communications, that are capable of carrying instructions detectable by a physical mechanism for input to a machine.

Computer system 2500 can also include a communication interface 2518 coupled to bus 2502, for two-way data communication coupling to a network link 2520 connected to a local network 2522. Network link 2520 can provide data communication through one or more networks to other data devices. For example, network link 2520 may provide a connection through local network 2522 to a host computer 2524 or to data equipment operated by an Internet Service Provider (ISP) 2526 to access through the Internet 2528 a server 1130, for example, to obtain code for an application program.

For purposes of reference, the following section presents a glossary of some terms used in the present application. It should be understood that these terms also encompass the descriptions provided above with respect to FIGS. 1-25.

Memory Medium—Any of various types of memory devices or storage devices. The term “memory medium” is intended to include an installation medium, for example, a CD-ROM, floppy disks, or tape device; a computer system memory or random access memory such as DRAM, DDR RAM, SRAM, EDO RAM, Rambus RAM; or a non-volatile memory such as a magnetic media, for example, a hard drive, or optical storage. The memory medium may comprise other types of memory as well, or combinations thereof. In addition, the memory medium may be located in a first computer in which the programs are executed, and/or may be located in a second different computer which connects to the first computer over a network, such as the Internet. In the latter instance, the second computer may provide program instructions to the first computer for execution. The term “memory medium” may include two or more memory mediums which may reside in different locations, for example, in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Some software programs include programs written in text-based programming languages, such as C, C++, PASCAL, FORTRAN, COBOL, JAVA, assembly language, among others; graphical programs (programs written in graphical programming languages); assembly language programs; programs that have been compiled to machine language; scripts; and other types of executable software. A software program may comprise two or more software programs that interoperate in some manner.

Hardware Configuration Program—a program providing, for example, a netlist or bit file, that can be used to program or configure a programmable hardware element.

Graphical Program—A program comprising a plurality of interconnected blocks or icons, wherein the plurality of interconnected blocks or icons visually indicate and determine functionality of the program. This disclosure provides examples of various aspects of graphical programs. These examples and discussion are not intended to limit the above definition of graphical program, but rather provide examples of what the term “graphical program” encompasses. All terms presented should be understood to further include any descriptions provided above.

The blocks in a graphical program may be connected in one or more of a data flow, control flow, and/or execution flow format. The blocks may also be connected in a “signal flow” format, which is a subset of data flow. Some graphical program development environments which may be used to create graphical programs include LabVIEW®, DasyLab™, DiaDem™ and Matrixx/SystemBuild™ from National Instruments, Simulink® from the MathWorks, VEE™ from Agilent, WiT™ from Coreco, Vision Program Manager™ from PPT Vision, SoftWIRE™ from Measurement Computing, Sanscript™ from Northwoods Software, Khoros™ from Khoral Research, SnapMaster™ from HEM Data, VisSim™ from Visual Solutions, ObjectBench™ by SES (Scientific and Engineering Software), and VisiDAQ™, from Advantech, among others.

The term “graphical program” includes models or block diagrams created in graphical modeling environments, wherein the model or block diagram comprises interconnected blocks or icons that visually indicate operation of the model or block diagram; some graphical modeling environments include Simulink®, SystemBuild™, VisSim™ Hypersignal Block Diagram™, among others.

A graphical program may be represented in the memory of the computer system as data structures and/or program instructions. These data structures and/or program instructions representing the graphical program may be compiled or interpreted to produce machine language that accomplishes the desired method or process as shown in the graphical program. Input data to a graphical program may be received from any of various sources, such as from a device, unit under test, a process being measured or controlled, another computer program, a database, or from a file. Also, a user may input data to a graphical program or virtual instrument using a graphical user interface, for example, a front panel. A graphical program may optionally have a GUI associated with the graphical program. In this case, the plurality of interconnected blocks are often referred to as the block diagram portion of the graphical program.

Block—In the context of a graphical program, an element that may be included in a graphical program. A block may have an associated icon that represents the block in the graphical program, as well as underlying code or data that implements functionality of the block. Some blocks include function blocks, sub-program blocks, terminal blocks, structure blocks, among others. Blocks may be connected together in a graphical program by connection icons or wires. The blocks in a graphical program may also be referred to as graphical program nodes or simply nodes.

Wire—a graphical element displayed in a diagram on a display that connects icons or nodes in the diagram. The diagram may be a graphical program (where the icons correspond to software functions), a system diagram (where the icons may correspond to hardware devices or software functions), among others. A wire is generally used to indicate, specify, or implement communication or other interoperation between the icons. Wires may represent logical data transfer between icons, or may represent a physical communication medium, such as Ethernet, USB, among others. Wires may implement and operate under various protocols, including data flow semantics, non-data flow semantics, among others. Some wires, for example, buffered data transfer wires, may be configurable to implement or follow specified protocols or semantics. Wires may indicate communication of data, timing information, status information, control information, and/or other information between icons. In some embodiments, wires may have different visual appearances which may indicate different characteristics of the wire (for example, type of data exchange semantics, data transfer protocols, data transfer mediums, and/or type of information passed between the icons, among others). Where wires are displayed in state diagrams or statecharts, the wires may indicate transitions between states that are represented as state icons in the state diagram or statechart.

Pin—A pin is associated with an output or an input, and can be drawn as a graphical element between components. In some implementations, individual values or portions of values being sent or received can be displayed within the component.

Threads—the smallest sequence of programmed instructions that can be managed independently by a scheduler, which is typically a part of a computer operating system. The implementation of threads and processes differs between operating systems, but in most cases a thread is a component of a process. Multiple threads can exist within one process, executing concurrently and sharing resources such as memory, while different processes do not share these resources. In particular, the threads of a process share its executable code and the values of its variables at any given time. In some cases, multi-threaded program may include advantages over a single-threaded program, whereby the user interface may still be usable while the calculations take place in the background in a multi-threaded program (in contrast to single-threaded programs).

Graphical Data Flow Program (or Graphical Data Flow Diagram)—A graphical program or diagram comprising a plurality of interconnected blocks, wherein at least a subset of the connections among the blocks visually indicate that data produced by one block is used by another block. A LabVIEW VI is one example of a graphical data flow program. A Simulink block diagram is another example of a graphical data flow program.

Graphical User Interface—this term is intended to have the full breadth of its ordinary meaning. The term “Graphical User Interface” is often abbreviated to “GUI”. A GUI may comprise only one or more input GUI elements, only one or more output GUI elements, or both input and output GUI elements. The following provides examples of various aspects of GUIs. The following examples and discussion are not intended to limit the ordinary meaning of GUI, but rather provide examples of what the term “graphical user interface” encompasses.

A GUI may comprise a single window having one or more GUI Elements, or may comprise a plurality of individual GUI Elements (or individual windows each having one or more GUI Elements), wherein the individual GUI Elements or windows may optionally be tiled together. A GUI may be associated with a graphical program. In this instance, various mechanisms may be used to connect GUI Elements in the GUI with nodes in the graphical program. For example, when Input Controls and Output Indicators are created in the GUI, corresponding nodes (for example, terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Front Panel—A Graphical User Interface that includes input controls and output indicators, and which enables a user to interactively control or manipulate the input being provided to a program, and view output of the program, while the program is executing. A front panel is a type of GUI. A front panel may be associated with a graphical program as described above. In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators.

Graphical User Interface Element—an element of a graphical user interface, such as for providing input or displaying output. Some graphical user interface elements comprise input controls and output indicators.

Input Control—a graphical user interface element for providing user input to a program. An input control displays the value input the by the user and is capable of being manipulated at the discretion of the user. Some input controls comprise dials, knobs, sliders, input text boxes, among others.

Output Indicator—a graphical user interface element for displaying output from a program. Some output indicators include charts, graphs, gauges, output text boxes, numeric displays, among others. An output indicator is sometimes referred to as an “output control”.

Statechart—A diagram that visually indicates a plurality of states and transitions between the states. The diagram comprises state icons connected by wires, where the state icons represent states and the wires represent transitions between the states. One or more of the state icons may represent a hierarchical state, where a hierarchical state is a state that includes one or more sub-states. For example, a statechart may include a state (a superstate) which includes states (substates). The substates may be AND states (for example, parallel or concurrently active states) or OR states (for example, states which are not concurrently active). The statechart may also include pseudostates (for example, forks, joins, and/or junctions). The statechart may be represented in the memory of the computer system as data structures and/or program instructions. The representation of the statechart stored in memory corresponds to the diagram and is either 1) executable; 2) operable to be converted to an executable program; or 3) interpretable, to perform the functionality indicated by the diagram. A “State Diagram” is a type of statechart which does not have hierarchical states.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are operable to acquire and/or store data. A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Some “stand-alone” instruments include oscilloscopes, multimeters, signal analyzers, arbitrary waveform generators, spectroscopes, and similar measurement, test, or automation instruments. A measurement device may be further operable to perform control functions, for example, in response to analysis of the acquired or stored data. For example, the measurement device may send a control signal to an external system, such as a motion control system or to a sensor, in response to particular data. A measurement device may also be operable to perform automation functions, in other words, may receive and analyze data, and issue automation control signals in response.

Subset—in a set having N elements, the term “subset” comprises any combination of one or more of the elements, up to and including the full set of N elements. For example, a subset of a plurality of icons may be any one icon of the plurality of the icons, any combination of one or more of the icons, or all of the icons in the plurality of icons. Thus, a subset of an entity may refer to any single element of the entity as well as any portion up to and including the entirety of the entity.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A method of developing a computer application, the method comprising:
presenting a graphical program on a computer, the computer including a processor, data bus, random access memory, a display device, a network interface and storage on the computer for storing executable applications;
displaying a plurality of graphical blocks, the plurality of graphical blocks including a first graphical block, a second graphical block, and a third graphical block;
in response to movement of a cursor, dragging a first wire representation from a first pin representation associated with the first graphical block to a second pin representation associated with the second graphical block, wherein the first pin representation represents an output and the second pin representation represents an input;
transmitting a first trigger output signal from the first graphical block to the second graphical block via the first wire representation, the first graphical block being in communication with the second graphical block via the first wire representation; and
receiving the first trigger output signal as a first trigger input signal at the second graphical block.

2. The method of claim 1, the method further comprising, in response to movement of a cursor, dragging a second wire from a third pin representation associated with the second graphical block to a fourth pin representation associated with the third graphical block, wherein the third pin representation represents an input and the fourth pin representation represents an output.

3. The method of claim 2, the method further comprising transmitting a second trigger output signal from the second graphical block to the third graphical block via the second wire representation, the second graphical block being in communication with the third graphical block via the second wire representation.

4. The method of claim 3, the method further comprising receiving the second trigger output signal as a second trigger input signal at the third graphical block, thereby completing execution of a first thread.

5. The method of claim 1, wherein a bootstrap property is utilized for initialization of the first graphical block.

6. The method of claim 1, wherein the first graphical block, the second graphical block, and the third graphical block are executed sequentially.

7. The method of claim 4, wherein the second trigger output signal is not transmitted before the first trigger input signal is received.

8. The method of claim 4, wherein the first graphical block receives a third trigger input signal while the first thread is being executed, thereby generating a second thread.

9. The method of claim 8, further comprising executing the first thread and the second thread in parallel.

10. The method of claim 8, further comprising executing the first thread and the second thread in series.

11. A method of developing a computer application, the method comprising:
presenting a graphical program on a computer, the computer including a processor, data bus, random access memory, a display device, a network interface and a storage means on the computer for storing executable applications;
displaying a plurality of graphical blocks, the plurality of graphical blocks including a switch block, a first graphical block, a first action block, and a first constant block;
activating the switch block;
stimulating, via the switch block, the first graphical block, thereby causing a first output signal to be transmitted from the first graphical block to the first action block;
receiving the first output signal as a second input signal at the first action block;
receiving a third input signal at the first action block from the first constant block, the third input signal including a data value that is a constant; and
executing a first task associated with the first action block based on the second input signal and the third input signal.

12. The method of claim 11, wherein the first task includes comparing the second input signal with the third input signal.

13. The method of claim 11, wherein the first task includes adding values stored in the second input signal and the third input signal to produce a second output signal.

14. The method of claim 12, further including transmitting the second input signal from the first action block to a condition gate block as a second output signal, and converting the second output signal to a True and False output.

15. The method of claim 14, further including transmitting the True and False output to a second graphical block, and executing an action associated with the second graphical block.

16. The method of claim 11, wherein activation of the switch block further causes the first output signal to be transmitted from the first graphical block to a second action block.

17. The method of claim 16, further including:
receiving the first output signal as a second input signal at the second action block;
receiving a fourth input signal at the second action block from a second constant block, the fourth input signal including a data value that is a constant; and
executing a second task associated with the second action block based on the second input signal and the fourth input signal.

18. The method of claim 11, wherein the plurality of graphical blocks further includes a camera block and an image converter block, and wherein an output of the camera block is transmitted to the image converter block via a drawn wire.

19. The method of claim 18, wherein activation of the switch block further occurs as a result of an interrupting trigger.

20. The method of claim 11, wherein activation of the switch block initiates a synchronous execution of tasks associated with each of the first graphical block, a second graphical block, and a third graphical block.
